(19) United States
(12) Patent Application Publication
(10) Pub. No.: US 2015/0134426 A1
(43) Pub. Date: May 14, 2015

(54) SYSTEM AND METHOD FOR A CONNECTION PLATFORM

(71) Applicant: RelateWays, Inc., Toronto (CA)

(72) Inventors: Lynn Marie Lejcher, Toronto (CA); Sean Thomas, Toronto (CA); Marc John Nicola Cattapan, Toronto (CA)

(21) Appl. No.: 14/540,416

(22) Filed: Nov. 13, 2014

Related U.S. Application Data
(60) Provisional application No. 61/903,793, filed on Nov. 13, 2013.
(60) Provisional application No. 61/927,818, filed on Jan. 15, 2014.
(60) Provisional application No. 61/982,660, filed on Apr. 22, 2014.

(51) Int. Cl. G06Q 10/06; H04L 12/18

(52) U.S. Cl. CPC G06Q 10/06395; H04L 12/1831
USPC 705/7.41

(57) ABSTRACT

A system and method for providing a connection platform between a supporter device and a participant device are provided. The method may include the steps of: storing a PathWays guide, the PathWays guide comprising a tree structure of a plurality of data nodes, each of the plurality of data nodes representing an ordered collection of data records; receiving one or more primary foci of a participant and an industry value of the participant from the participant device; retrieving a set of Mindset Questions from the data store based on the one or more primary foci and the industry value, the set of Mindset Questions forming part of the ordered collection of data records of one or more of the plurality of data nodes; transmitting the set of Mindset Questions to the at least one supporter device or the at least one participant device; triggering display of the set of Mindset Questions on a user interface; receiving a modification command in association with the set of Mindset Questions; modifying data records representing the set of Mindset Questions based on the received modification command; updating the one or more of the plurality of data nodes and the respective ordered collection of data records of the PathWays guide based on the modified data records representing the set of Mindset Questions; and triggering display of the updated PathWays guide on the user interface of the at least one participant device or the at least one supporter device.

### CROSS-REFERENCE TO RELATED APPLICATIONS

This application claims the benefit of U.S. Provisional Application No. 61/903,793 filed Nov. 13, 2013, U.S. Provisional Application No. 61/927,818 filed Jan. 15, 2014, and U.S. Provisional Application No. 61/982,660, filed Apr. 22, 2014, the entireties of which are hereby incorporated by reference.

### FIELD

The embodiments described herein relate to systems and methods for providing a platform for connecting user devices, and in particular, to systems and methods for providing a platform for user devices to connect with other user devices for the purposes of facilitating coaching, learning, career or life goal achievement, personal or professional improvement, and so on.

### BACKGROUND

Lack of employee engagement is an issue faced by managers and employers in general. For example, U.S. employee engagement may stagnate at just 30 percent of the workface, according to Gallup's 2013 State of the American Workplace report. This lack of employee engagement may contribute in part to billions in lost productivity. People may not be engaged by so called “employment engagement programs”.

In addition, traditional education, workshops and training may lose effectiveness due to lack of engagement. Traditional training methods may be event based and may be less likely to be retained and applied by students or learns over the long term.

Employees may find current performance management practices ineffective. Like traditional learning practices, performance management may be event based and addressed once or twice a year.

There exists a need for improved systems and methods for remote learning or at least alternatives. There also exists a need for providing a platform for people to coach and/or learn from one another, and to achieve career or life goals or at least alternatives. There further exists a need for improved systems and methods for effectively engaging employees or at least alternatives.

### SUMMARY

Embodiments described herein relate to a system for a connection platform between at least one supporter device and at least one participant device, the system may include: a processor operably connected to the at least one supporter device and the at least one participant device; an electronic data store persistently storing data reflecting a PathWays guide for the at least one participant device, wherein the PathWays guide may comprise or be represented by a tree structure of a plurality of data nodes, each of the plurality of data nodes representing an ordered collection of data records; a network interface for coupling to a network operably connected to the at least one supporter device and the at least one participant device; and a non-transitory computer-readable memory storage in communication with the processor, the memory storage storing processor-executable instructions. The processor, when executing the instructions, may cause the system to: receive electronic signals representing a first data record representing one or more primary foci of a participant operating the participant device, and a second data record representing an industry value of the participant; store the first and second data records in the data store, wherein each of the first and second data records forms part of the ordered collection of data records of one or more of the plurality of data nodes of the PathWays guide; retrieve a set of Mindset Questions from the data store based on the one or more primary foci and the industry value, the set of Mindset Questions forming part of the ordered collection of data records of one or more of the plurality of data nodes; transmit, the network interface, electronic signals representing the set of Mindset Questions to the at least one supporter device or the at least one participant device; trigger display of the set of Mindset Questions on a user interface of the at least one supporter device or the at least one participant device; receive electronic signals representing a modification command in association with the set of Mindset Questions via the network interface from the at least one supporter device or the at least one participant device; modify data records representing the set of Mindset Questions in the data store based on the received modification command; update the one or more of the plurality of data nodes and the respective ordered collection of data records of the PathWays guide based on the modified data records representing the set of Mindset Questions; and trigger display of the updated PathWays guide on the user interface of the at least one participant device or the at least one supporter device.

In an aspect of an embodiment described herein, the modification command in association with the set of Mindset Questions may include modifications to the one or more primary foci or the industry value.

A primary focus may be a focus area selected by a participant or a supporter. The one or more primary foci may be used to define a set of Mindset Questions related to the relevant focus areas or primary foci.

The industry value may be a value representing an industry, a profession, or a trade that the participant is in. The industry value may also be used to define a set of Mindset Questions related to the relevant industry, profession or trade.

In another aspect, the modification command in association with the set of Mindset Questions may include at least one answer to the set of Mindset Questions, and the at least one answer may be further stored in the data store as a data record forming part of an ordered collection of data records of one or more of the plurality of data nodes.

In yet another aspect, the system may record data signals representing one or more conversations exchanged between the at least one participant device and the at least one supporter device.

In still another aspect, the recorded conversations may be in the form of text, audio or video.

In one aspect, the recorded conversations may be further stored in the data store as a data record forming part of an ordered collection of data records of one or more of the plurality of data nodes of the PathWays guide and configured to be accessed by the at least participant device or the at least supporter device.

In another aspect, the system may determine a recommended next step for the participant based on a predefined route of the PathWays guide, wherein the predefined route comprises an ordered collection of data records of a data node of the plurality of data nodes.

In yet another aspect, the data store may persistently store a plurality of participant profiles including a profile of the participant, and wherein the at least one processor further causes the system to generate a report based on the plurality of participant profiles.

In still another aspect, the participant profile can include participant account information such as name, age, occupation, photo, address information. The participant profile can also include one or more primary foci options and one or more industry values as selected by the participant or the supporter. The participant profile may further include private notes, recorded conversations, commitments, next steps and progress of the participant.

In one aspect, the system may provide access of an ordered collections of data records of one or more of the plurality of data nodes of PathWays guide to one or more devices of the at least one participant's peers invited by the at least one participant or the at least one supporter.

In another aspect, the system may provide a single sign-on interface, via the network interface, for the at least one participant device or the at least one supporter device. The single sign-on interface may provide a user of the system with one login interface that allows the user to select and log into one master user account comprising with different roles, such as the role of a participant, the role of a supporter, or the role of an observer.

Embodiments described herein may provide a method for providing a connection platform between at least one supporter device and at least one participant device is provided, the method may include the steps of: storing persistently a PathWays guide for the at least one participant device in an electronic data store, wherein the PathWays guide comprises a tree structure of a plurality of data nodes, each of the plurality of data nodes representing an ordered collection of data records; receiving electronic signals representing a first data record representing one or more primary foci of a participant operating the participant device, and a second data record representing an industry value of the participant from the participant device via a network interface coupled to a network operably connected to the at least one supporter device and the at least one participant device; storing the first and second data records in the data store, wherein each of the first and second data records forms part of the ordered collection of data records of one or more of the plurality of data nodes of the PathWays guide; retrieving a set of Mindset Questions from the data store based on the one or more primary foci and the industry value, the set of Mindset Questions forming part of the ordered collection of data records of one or more of the plurality of data nodes; transmitting, via the network interface, electronic signals representing the set of Mindset Questions to the at least one supporter device or the at least one participant device; triggering display of the set of Mindset Questions on a user interface of the at least one supporter device or the at least one participant device; receiving electronic signals representing a modification command in association with the set of Mindset Questions via the network interface from the at least one supporter device or the at least one participant device; modifying data records representing the set of Mindset Questions in the data store based on the received modification command; updating the one or more of the plurality of data nodes and the respective ordered collection of data records of the PathWays guide based on the modified data records representing the set of Mindset Questions; and triggering display of the updated PathWays guide on the user interface of the at least one participant device or the at least one supporter device.

In still another aspect, the method may include the step of recording data signals representing one or more conversations exchanged between the at least one participant device and the at least one supporter device.

In yet another aspect, recorded conversations may be in the form of text, audio or video.

In one aspect, the method may include the step of determining a recommended next step for the participant based on a predefined route of the PathWays guide, wherein the predefined route comprises an ordered collection of data records of a data node of the plurality of data nodes.

In another aspect, the method may include the step of providing access of an ordered collections of data records of one or more of the plurality of data nodes of PathWays guide to one or more devices of the at least one participant's peers invited by the at least one participant or the at least one supporter.

In yet another aspect, the method may include the step of providing a single sign-on interface, via the network interface, for the at least one participant device or the at least one supporter device.

In various further aspects, the disclosure provides corresponding systems and devices, and logic structures such as machine-executable coded instruction sets for implementing such systems, devices, and methods.

In this respect, before explaining at least one embodiment in detail, it is to be understood that the disclosure is not limited in its application to the details of construction and to the arrangements of the components set forth in the following description or illustrated in the drawings. Other embodiments are possible and may be practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments are illustrated by way of example. It is to be expressly understood that the description and drawings are only for the purpose of illustration and as an aid to understanding, and are not intended as a definition of the limits of the present disclosure.

Various embodiments will now be described, by way of example only, with reference to the following drawings, in which:

FIG. 1 is a schematic diagram of a system for providing a platform for connecting people according to some embodiments;

FIG. 2 is a system block diagram of a connection platform according to some embodiments;

FIG. 3 is a schematic diagram of a PathWays Guide according to some embodiments;

FIG. 4 is a flowchart for a Conversation as provided by a connection platform accordingly to some embodiments;

FIG. 5 is a schematic diagram illustrating a computer device, and associated communications networks, devices, software and firmware that may be configured to provide a platform for enabling one or more embodiments as described above.

FIG. 6 is a user interface of a practitioner registration page for a connection platform according to some embodiments;

FIG. 7 is another user interface of a practitioner registration page for a connection platform according to some embodiments;

FIG. 8 is yet another user interface of a practitioner registration page for a connection platform according to some embodiments;

FIG. 9 is a user interface of a practitioner account setup notification page for a connection platform according to some embodiments;

FIG. 10 is a user interface of a participant registration page for a connection platform according to some embodiments;

FIGS. 11 and 12 illustrates another user interface of a participant registration page for a connection platform according to some embodiments;

FIG. 13 is a user interface of a participant registration page providing a participant profile option for a connection platform according to some embodiments;

FIG. 14 is a user interface of a participant setup notification page for a connection platform according to some embodiments;

FIGS. 15a and 15b show various user interfaces of a sample participant interface and a coach interface provided by a connection platform according to some embodiments;

FIG. 16 is a user interface showing a Practitioner Profile of a coach provided by a connection platform according to some embodiments;

FIG. 17 illustrates a user interface showing “My Participants” for a host or coach provided by a connection platform according to some embodiments;

FIG. 18 is a user interface showing an overview section of a participant's PathWays Guide provided by a connection platform according to some embodiments;

FIG. 19a illustrates a user interface showing a path section of a participant's PathWays Guide alongside a conversation room provided by a connection platform according to some embodiments;

FIGS. 19b and 19c illustrate sample user interfaces showing alternative views of a Path of a participant based on a PathWays Guide provided by a connection platform according to some embodiments;

FIG. 20 illustrates a user interface showing a note section of a participant based on a PathWays Guide provided by a connection platform according to some embodiments;

FIG. 21 illustrates a user interface showing a reflect or archive section of a participant based on a PathWays Guide provided by a connection platform according to some embodiments;

FIG. 22 illustrates a user interface of a list of upcoming conversations for a coach provided by a connection platform according to some embodiments;

FIG. 23 illustrates a user interface of conversation scheduling calendar for booking a conversation by a coach provided by a connection platform according to some embodiments;

FIG. 24 illustrates user interface of “My Calendar” interface for a coach provided by a connection platform according to some embodiments;

FIG. 25 illustrates a user interface of a participant interface provided by a connection platform according to some embodiments;

FIG. 26 illustrates a user interface of conversation scheduling or booking by a participant provided by a connection platform according to some embodiments;

FIG. 27 illustrates a user interface of list of users available to chart as provided by a connection platform according to some embodiments;

FIG. 28 illustrates a user interface of list of available conversations to observe provided by a connection platform according to some embodiments;

FIG. 29 illustrates a user interface of Upcoming Conversations for a participant provided by a connection platform according to some embodiments;

FIG. 30 illustrates a user interface showing an overview section of a PathWays Guide for a participant as provided by a connection platform according to some embodiments;

FIG. 31 illustrates a user interface showing a calendar for a participant to book a conversation with a coach as provided by a connection platform according to some embodiments;

FIG. 32 illustrates a user interface showing a path section of a participant's PathWays Guide alongside a scheduled conversation with a coach according to some embodiments;

FIG. 33 illustrates a user interface showing a note section of a participant's PathWays Guide alongside a scheduled conversation with a coach according to some embodiments;

FIG. 34 illustrates a user interface showing a reflect section of a participant's PathWays Guide alongside a scheduled conversation with a coach according to some embodiments; and

FIG. 35 is a user interface of a host landing page according to some embodiments.

The above figures may provide some sample user interfaces related to some embodiments. These screenshots are provided for example purposes and are meant to be non-limiting.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

### DETAILED DESCRIPTION OF VARIOUS EMBODIMENTS

A small portion of employees find current performance management practices effective. Like traditional learning practices, performance management may be often event based and addressed once or twice a year. There is a need to support performance in a more ongoing manner. When a strength based approach is applied to performance activities, it may boost productivity.

Further, in the healthcare industry, evidence shows that the benefits of integrated ongoing support to nurses, doctors and patients may affect the health status of patients.

There exists a need for improved systems and methods for and to scale people development, and to achieve career or life and organizational (e.g. family, group, workplace) goals. There exists a need for improved system and method for effectively engaging people through a connection platform that enables real-time communication, paired with proven, accredited methodologies (embedded intelligence) to guide development, support and learning of people.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic optical, and electronic storage media, volatile memory, non-volatile memory and the like. Non-transitory computer-readable media comprise all computer-readable media, with the exception being a transitory, propagating signal. The term non-transitory is not intended to exclude computer readable media such as a volatile memory or RAM, where the data stored thereon is only temporarily stored. The computer useable instructions may also be in various forms, including compiled and non-compiled code.

Throughout the following discussion, numerous references will be made regarding servers, services, interfaces, devices, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may establish network connections between user systems, persistently store and manage electronic profiles and PathWays Guides for users, and other technical effects.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It is to be understand that throughout this application, “coach”, “supporter” and “practitioner” are interchangeable terms; they all mean a user who is capable of supporting, advising, giving suggestions, education, tips, advice, instructions, or guidance to another user (e.g. a “participant”). Coach, practitioner, and client are all examples of users of a system for providing a platform for connecting people according to some embodiments. These are illustrative terms for a user capable of advising another user. Variations may also be used.

According to one or more aspects of the embodiments described herein, an Individualized Engagement Platform 150 is described in this application. The Individualized Engagement Platform may also be referred to as a “Guiding Framework and Engagement Platform”, a “Personal Growth and Relationship Building Platform”, an “Engagement Platform” or a connection platform 150. This connection platform 150 connects various devices to help individuals and employees using the devices to engage with peers, coaches, and management personnel using other devices. The connection platform 150 may configure two-way reinforcement and accountability tools available to be assessed by devices operated by organizations and practitioners. The connection platform 150 may provide individuals and organizations with electronic tools and digital virtual space to explore and map next steps together. A PathWays Guide may be an electronic tool to manage aspects of connections for a user. Each PathWays Guide may be unique and specific to a user.

According to another aspect of embodiments, a PathWays Guide 300 can be designed to operate independent of conversations, and/or operate in a public environment. The Connection platform 150, including the PathWays Guide 300, can be also a personal growth and influence tool operable to be assessed by participants and supporters via devices connected to a network 110.

In one embodiment, the PathWays guide 300 may be a data structure (e.g. a tree structure) of a plurality of data nodes, each of the plurality of data nodes representing an ordered collection of data records. The data nodes may be Overview node 355, a Path node 340, a Note node 350 and a Reflect node 360. Each of the data nodes may further include an ordered collection of data records. For example, the Overview node 355 may include data records such as participant profiles, industry value, primary foci, strengths or identifiers, contact information. The Path node 350 may include primary foci, strengths or identifiers, commitments, next steps, Mindset Questions, progress bar and so on. The Note node 350 may include private, public or semi-private notes taken by the participant 130 or the coach 120. The Reflect node 360 may include one or more recorded conversations or uploaded files.

Each of the ordered collection of data records may store data fields defining a predefined route or path for a participant to take. In some embodiment, the predefined route or path may also be provided by the Embedded Interaction Intelligence process and guide 370 (or simply referred to as the “EII process 370”), implemented by the Embedded Interaction Intelligence module 270 (or simply referred to as the “EII 270”).

As described herein, the connection platform 150 may (e.g. RelateWays™) provide a virtual platform to enable devices to be connected so that participants and other types of users can be supported.

In one embodiment, the connection platform 150 may offer the following solutions to users: A) coordination, B) connection, and C) cultivation.

Coordination may include functionalities such as: 1) Manage Availability through My Calendar tool; 2) Booking Schedule Conversations; 3) Review and Prepare: Client/Participant path; and 4) Communicate: Send docs/links.

Connection may include functionalities or features such as: 1) personalized environment; 2) conversations in text, audio, video or all three formats; 3) communication between 1-1, small group, or simply observation; 4) synchronization with PathWays tools.

Cultivation may include functionalities or features such as: 1) stay informed: Client/Participant path; 2) stay tuned: listen to recordings; 3) support: send links, docs; and 4) self or peer review: reporting available.

A Pathways Guide 300 may also be provided to the users on associated user devices. The Pathways Guide 300 may be personalized in some embodiments. A Pathways Guide 300 can provide the following functionalities or features to a participant device or supporter device: a) identify Primary Focus or Foci 325; b) set Conversation Topic; c) create Next Steps 346; d) Create journal or note entries 350; e) send documents/links; and f) record all conversations and other data. Each of the features may include one or more data fields or data records that form part of an ordered collection of data records, and each ordered collection of data records may be represented by a data node belonging to the Pathways Guide 300.

In addition, a reporting tool such as Pathways Guide Reporting is available to offer management intelligence regarding employment engagement and progress.

The connection platform 150 may be designed and implemented to address the new economy of shared skills, expertise and intelligence. The connection platform 150 may provide one or more of the following: 1) a vehicle or data container for the exchange of data signals defining a range of data fields from classes ranging from education, training, support to skills; 2) an embedded interaction intelligence module 270 which implements heuristic techniques and other types of learning that may be applied, actualized and integrated into an individual growth path (e.g. Path 340 of the PathWays Guide 300); and 3) meaningful measurement of the process of each participant and his or her learning and growth, which can be benchmarked against the other participants.

The Connection platform 150 may thus deliver and scale the next generation technology of people development, support and learning. The connection platform 150 can facilitate learning experience in a relaxed space within an advanced framework including both guided process and next steps. In addition, skills-based content as well as client content dashboard may also be added to the framework to provide a further customized learning experience.

In some embodiments, various training and engagement methodologies, such as Strength, Growth, Leadership Development, Decision-making, Productive Thinking and Positive Psychology methodologies, can be built-in to a PathWays Guide 300 and the conversation framework.

In one embodiment, alignment mechanisms through data records such as primary focus values or industry values can be built into the framework, designed by and for organizations/groups and their members/employees/individuals. The primary focus values or industry values may be data records stored as part of ordered collection of data records for one or more data nodes (e.g. Overview node and/or Path node) of the PathWays Guide 300.

In another embodiment, commitment, next steps and accountability mechanisms can also be built in the framework as part of an ordered collection of data records of a data node for the PathWays Guide 300.

In another embodiment, progression scale can be built in for each commitment set as part of an ordered collection of data records of a data node for the PathWays Guide 300.

In another embodiment, group management capabilities may be provided. For example, there may be client groups or company groups, with each group being linked to multiple participant profiles. A participant profile may be linked, or otherwise associated with one or more groups.

In yet another embodiment, binary, dual and group interaction capabilities may be provided with PathWays both in and out of conversations.

In one embodiment, the connection platform 150 can offer individual centric solution: e.g. providing for multiple sounding board members and community member support. Because it is individual/user centric, all sounding board members and invited community members supporting the individual and groups can have access, via their respective devices, to the individual and group PathWays.

In another embodiment, PathWays guide reporting and history capabilities are provided at individual, group and organizational levels to offer data segmentation and organization at different levels of data granularity.

In another embodiment, Calendar Availability management is provided for easy booking based on availability of participant and/or coach, including capabilities to synchronize with local calendar applications on the participant or coach's device.

The connection platform 150 can support, manage, measure and reinforce organizational/system/group: engagement, development, alignment, retention and accountability from a single source.

The connection platform 150 can further offer holistic ongoing, continuous support across the cycle of individual/group relationship with an organization onboarding to development to transition. The connection platform 150 is also able to support multiple applications including but not limited to: organizational, education, military, and group environments.

In one embodiment, the Connection platform 150 can offer easy brand/logo placement for branded experience.

In another embodiment, the Connection platform 150 can offer open/community capabilities including: single registration and sign-on based on visit type; invite and accept features; tag and post; chat (outside of booked conversation) features.

In one embodiment, the single sign-on feature may be seamless and allow a participant device or a coach device to access different roles (e.g. coach, mentor, participant or peer) all under one master user account or profile. The roles may define what subset of data and access rights are provided to the device in association with the user role.

In another embodiment, the connection platform 150 can offer notification of PathWays updates.

The connection platform 150 can be available on mobile and tablet devices.

The connection platform 150 also can provide Building for seamless log-in integration with organizations.

In some embodiments, the connection platform 150 can be configured to enable users to support each other applying positive psychology, professional coaching, strength and growth based methodologies, which can be implemented via both conversation functionality and the PathWays Guide, which has the leadership and decision-making development, productive thinking methods, strength based practices, and positive psychology built in as described above (e.g. EII process 370).

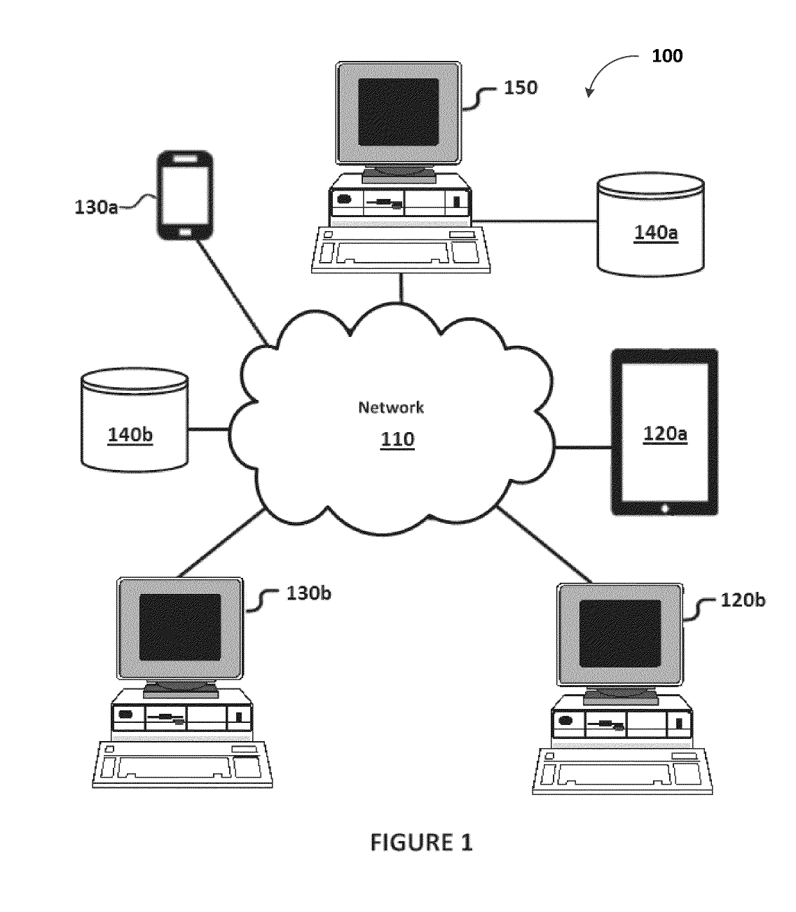

Turning now to FIG. 1, system 100 includes a connection platform 150 to enable people (e.g. users) to feel connected and supported, while free to express and explore as they move toward career or life goals. Digital connections and technology can be configured using control logic to enable users to connect via the electronic connection platform 150 and facilitate users bringing out the best in each other while avoiding overwhelming people with endless messages or conference meetings. The system 100 can help people create a confident path (e.g. via PathWays Guide tool) towards what they want to accomplish by offering a refuge from everyday noise and from a hyper-connected world. Such a refuge, similar to a digital living room, a virtual private office, or a personal playground, can be a space to connect, explore and map next steps with support from experts, educators, tutors, coaches or peers. Each participant may act as “personal sound board” for other participants. It is also a space to organize and align priorities. The connection platform 150 provides a comfortable virtual connection space for devices to connect and exchange real-time dynamic content, with a convenient, easy and scalable way to meet with personal connections or select partners for productive, structured conversation experiences to address what people want to accomplish, process or develop and decide how to move forward. The connection platform 150 can also provide real-time, anytime access to an interactive personalized guide (e.g. PathWays Guide 300 tool), fueling and managing next steps for goal achievement through data exchanges enabled by the Embedded Interaction Intelligence process 370 that can suggest Mindset Questions 342 to a participant or coach device. The connection platform 150 offers conversations that may be one-on-one. Alternatively, participants may invite others to drop-in to share in the learning. In addition, the connection platform 150 can draw on strengths and values of one or more users or participants to align mutual priorities and create enduring engagement programs. Overall, connection platform 150 is a place to invest in talent, personal growth and achievement.

As previously stated, connection platform 150 is one example of the overall system and architecture embedding a connection platform 150, which connects devices for data exchanges for personalized conversations and provide experiences tailored for what they want to accomplish, process, or develop.

In addition, the system 100 can provide organizations and groups the means to deliver scalable, enduring engagement practices.

According to some embodiments described herein, the connection platform 150 can provide a convenient, comfortable virtual space for individuals or groups to converse or reflect on their respective devices through user-friendly and guided interfaces as implemented by the connection platform 150 with a coach, mentor, peer, or educator while building their Personalized PathWays Guide using the electronic PathWays Guide tool (e.g. electronic utility). Conversation experiences are personalized for each individual and designed to guide people through what they want to accomplish, process, or develop.

Participants may keep or carry their experiences and conversations with them to fuel and manage next steps, as the conversations are archived in the system; the Personalized PathWays Guide is available “in” and “out” of conversations. The Personalized PathWays Guide is specific and unique to each user. The connection platform 150 may link each Personalized PathWays Guide to a specific user via a user identifier, for example. In other embodiments, each participant profile may be linked to, or include the respective PathWays Guide of the participant.

Organizations also benefit from an innovative, unique place to invest in talent, personal growth and achievement. The system 100 may be designed to integrate key objectives and align mutual priorities to create enduring engagement practices and to keep learning ongoing and alive. Customized reporting, such as PathWays guide reporting, provides continued learning to enhance individual and organizational experiences.

In addition, embodiments described herein can also offers consulting, facilitation and professional coaching services.

According to some other aspects of embodiments described herein, a plurality of features may be available with a system for providing a connection platform described herein, such as:

PathWays Guide 300 can provide the following functionalities: accessing the personalized electronic PathWays Guide to manage next steps through data exchanges between at least two devices; viewing/listening to recorded conversations; reflecting with notes; checking-in and updating a personal plan or path profile. The electronic PathWays Guide tool enables creation, modification and management of a PathWays Guide.

Conversations 850 can provide the following functionalities: easily connecting live with a device of a mentor, peer, coach, or educator, 1-on-1, in a group, or allowing others to receive a corresponding copy of voice, audio or text data signals; and electronic interfaces for observing the conversation, often guided by the EII process 370.

Conversations 850 can be in the form of audio, video and/or text, or all three at the same time.

Conversation Calendar (or otherwise known as “My Calendar”) can provide a Conversation Calendar tool to book and manage conversation.

Multiple Client or Participants Groups 805 can organize and manage clients or participants by communities or organizations.

Unique Branding tool can provide brand and banner placement for sponsors or organizations.

As shown in FIG. 1, there is shown a schematic diagram of a system for providing a platform for connecting user devices according to some embodiments. There is a network 110 operably connected to one or more supporter or participant devices, one or more coach or supporter devices (or simply “coaches” or “supporters”) 120a and 120b, one or more client or participant devices (or simply “clients” or “participants”) 130a and 130b, at least one optional data storage 140b and a connection platform 150, which is further connected to a data storage device 140a.

Network 110 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although not shown, connection platform 150, coach devices 120a, 120b, participant devices 130a, 130b, data storage 140a, 140b and other components (not shown) may connect to network 110 via a firewall, which is a device, set of devices or software that inspects network traffic passing through it, and denies or permits passage based on a set of rules and other criteria. Firewall may be adapted to permit, deny, encrypt, decrypt, or proxy all computer traffic between network 110, connection platform 150, coach devices 120a, 120b, participant devices 130a, 130b, data storage 140a, 140b and other components based upon a set of rules and other criteria. For example, firewall may be a network layer firewall, an application layer firewall, a proxy server, or a firewall with network address translation functionality. Network 110 is operable to secure data transmissions using encryption and decryption.

Optional data storage device 140a, 140b may be a cloud storage operable to store the connection platform 150 and the devices 120, 130 on demand.

Communication between the user devices (i.e., the coaches 120a, 120b and the participants 130a and 130b) and between the user devices and the connection platform 150 may occur either directly or indirectly using any suitable computing device. For example, coach 120b may use a computing device such as a desktop computer that has at least one input device (e.g. a keyboard and a mouse) and at least one output device (e.g. a display screen and speakers). Coach 120a may be using a tablet device, participant 130b may be using a laptop, and client 130a may be using a mobile device.

It is to be appreciated that a coach may also be referred to as a supporter, mentor, an advisor, a consultant, a teacher, a tutor, an educator, a therapist, a psychologies, a psychiatrist, a specialist, a facilitator, and so on.

System 100 may include one or more devices 120, 130 accessible by user devices (e.g. coaches 120 and/or participants 130) to access the connection platform 150 to enable the users to connect and participate in conversations among other activities. The devices 120, 130 may be implemented using one or more processors and one or more data storage devices configured with database(s) or file system(s), or using multiple servers or groups of servers distributed over a wide geographic area and connected via a network (which may be referred to as “cloud computing”).

Both coach devices 120 and participant devices 130 may reside on any networked computing device, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these.

Each of the coach devices 120 and participant devices 130 may include one or more input devices, such as a keyboard, mouse, camera, touch screen and a microphone, and may also include one or more output devices such as a display screen and a speaker. Devices 120, 130 have a network interface in order to communicate with other components, to serve an application and other applications, and perform other computing applications by connecting to network 110 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only four devices 120, 130 are shown for simplicity and clarity, there may be more devices 120, 130 distributed over a wide geographic area and connected via e.g. network 110. Both coach and participant devices are operable to register and authenticate users (using a login, unique identifier, and password for example) prior to providing access to connection platform 150. Devices 120, 130 may be different types of devices and may serve one user or multiple users.

Though not shown in FIG. 1, system may also include an administrator device. The administrator device may be implemented using one or more processors and one or more data storage devices configured with database(s) or file system(s), or using multiple servers or groups of servers distributed over a wide geographic area and connected via a network (so called which may be referred to as cloud computing). The administrator device may reside on any networked computing device, such as described herein in relation to devices 120, 130, or in relation to cloud storage 140b. The administrator device may be used by an administrative user to configure components of system 100. The administrator may have access and permissions to configure different components of system 100, where such administrative access and permissions are not permitted for other users. For example, administrator users may be permitted to administer and/or define global configuration profiles for the system 100, define roles and/or groups within the system 100, set security profiles associated with the roles and/or groups, and assign the roles and/or groups to particular users in the system 100. The administrator may manage one or more components of the system 100. There may be more than one administrator devices distributed over a wide geographic area and connected via e.g. network 110. The administrator device may require security authorization and authentication via a log in and password, in order to modify and configure components. The administrator device is operable to register and authenticate users (using a login, unique identifier, and password for example) prior to providing access to connection platform 150. The administrator device may be different types of devices and may serve one user or multiple users.

Coach devices 120, participant devices 130, and one or more administrator devices may be configured with various computing applications, as will be described herein. A computing application may correspond to hardware and software modules comprising computer executable instructions to configure physical hardware to perform various functions and discernible results. A computing application may be a computer software or hardware application designed to help the user to perform specific functions, and may include an application plug-in, a widget, instant messaging application, mobile device application, e-mail application, online telephony application, Java application, web page, or web object residing, executing, running or rendered on the respective device. The device may include a computing application in order to access the functionality of connection platform 150, by providing and receiving data and carrying out actions and instructions, for example.

Connection platform 150 may be implemented using a server and data storage devices configured with database(s) or file system(s), or using multiple servers or groups of servers distributed over a wide geographic area and connected via a network 110. Connection platform 150 may include or be connected to a data storage device directly 140a or indirectly via a cloud based data storage device 140b. Connection platform 150 may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. The data storage devices may be used to provide a persistent store for the users' data. Accordingly the connection platform 150 may collect and store learning data for a user, index the data for storage, and enable subsequent search and retrieval.

Connection platform 150 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Connection platform 150 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

Connection platform 150 may include one or more input devices, such as a keyboard, mouse, camera, touch screen and a microphone, and may also include one or more output devices such as a display screen and a speaker. Connection platform 150 has a network interface in order to communicate with other components, to serve an application and other applications, and perform other computing applications by connecting to network 110 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one connection platform 150 is shown for clarity, there may be multiple platforms 150 or groups of platforms 150 distributed over a wide geographic area and connected via e.g. network 110.

In one exemplary embodiment described herein, coach or supporter devices 120a, 120b can communicate with participant devices 130a, 130b in real-time or substantially real-time. The communication record or log may be stored in non-transitory computer-readable data storage 140.

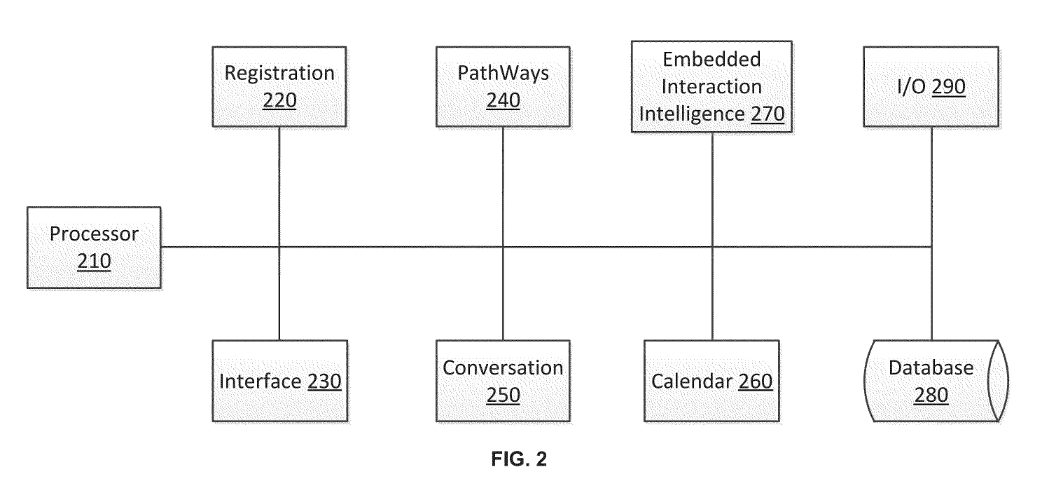

FIG. 2 is a schematic diagram of a connection platform 150 according to some embodiments. Connection platform 150 includes a processor 210 operable to execute program instructions stored in a non-transitory computer-readable storage medium. The processor may execute control logic to provide a variety of functional hardware modules. For example, processor may provide a registration module 220, an interface module 230, a PathWays module 240, a conversation module 250, a calendar module 260, an Embedded Interaction Intelligence 270, an input/output (I/O) module 290, and an optional data storage device 280 that may be a non-transitory computer-readable storage medium.

Data storage device 280 can receive, store and retrieve input data from the processor 210, all the modules 220, 230, 240, 250, 260, 270, 290 and any other types of data the connection platform 150 generates or receives (e.g. participant profile data or PathWays guide data). Data storage device 280 may be connected to various modules such as registration module 220, an interface module 230, a PathWays module 240 to provide PathWays Guide 300, a conversation module 250, a calendar module 260, and an input/output (I/O) module 290. The modules may be computer software or hardware applications designed to help the user to perform specific functions, and may include an application plug-in, a widget, instant messaging application, mobile device application, e-mail application, online telephony application, Java application, web page, or web object residing, executing, running or rendered on the connection platform 150. There may be corresponding modules provided on coach devices 120 and participant devices 130.

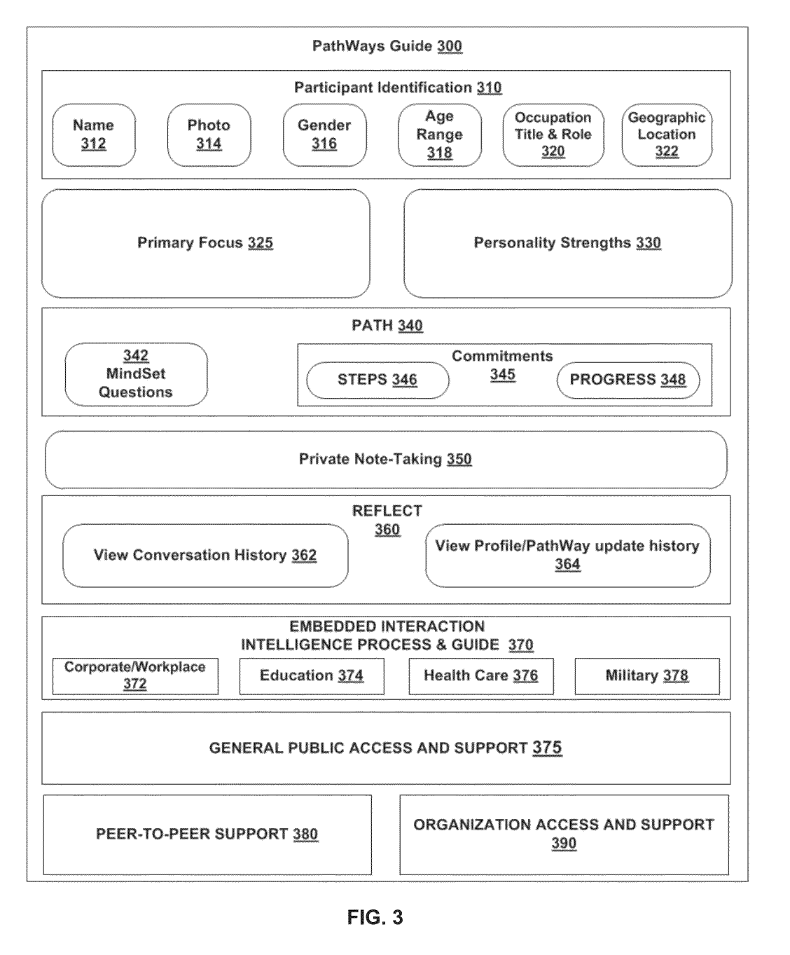

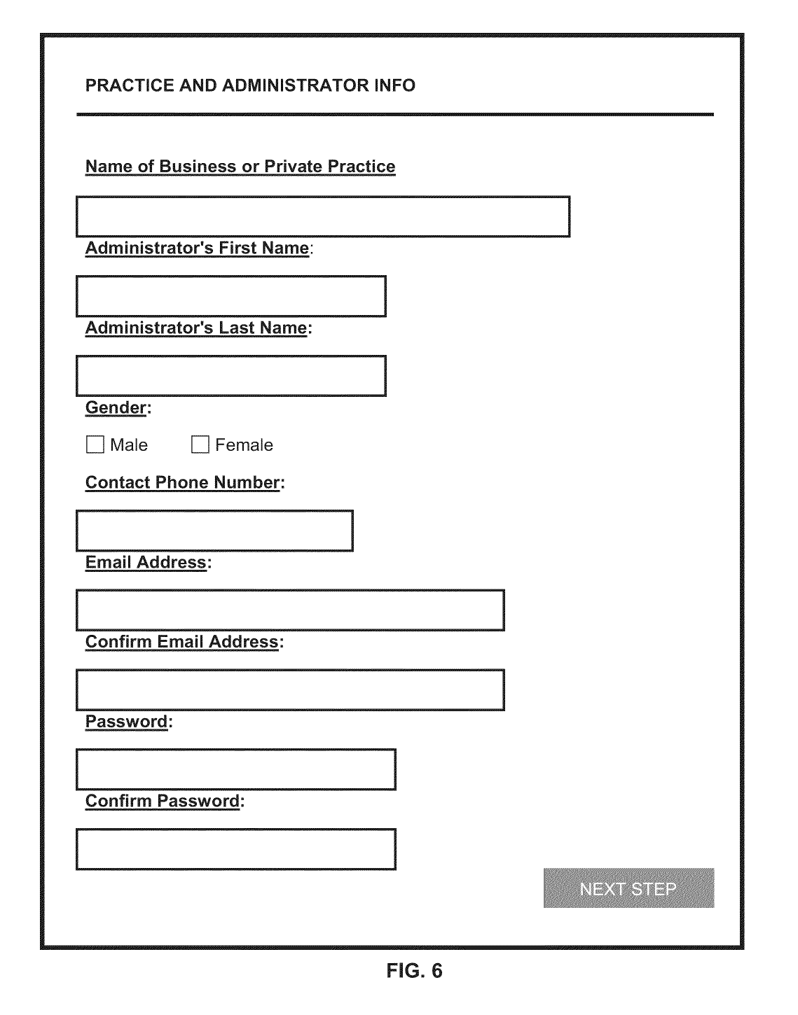

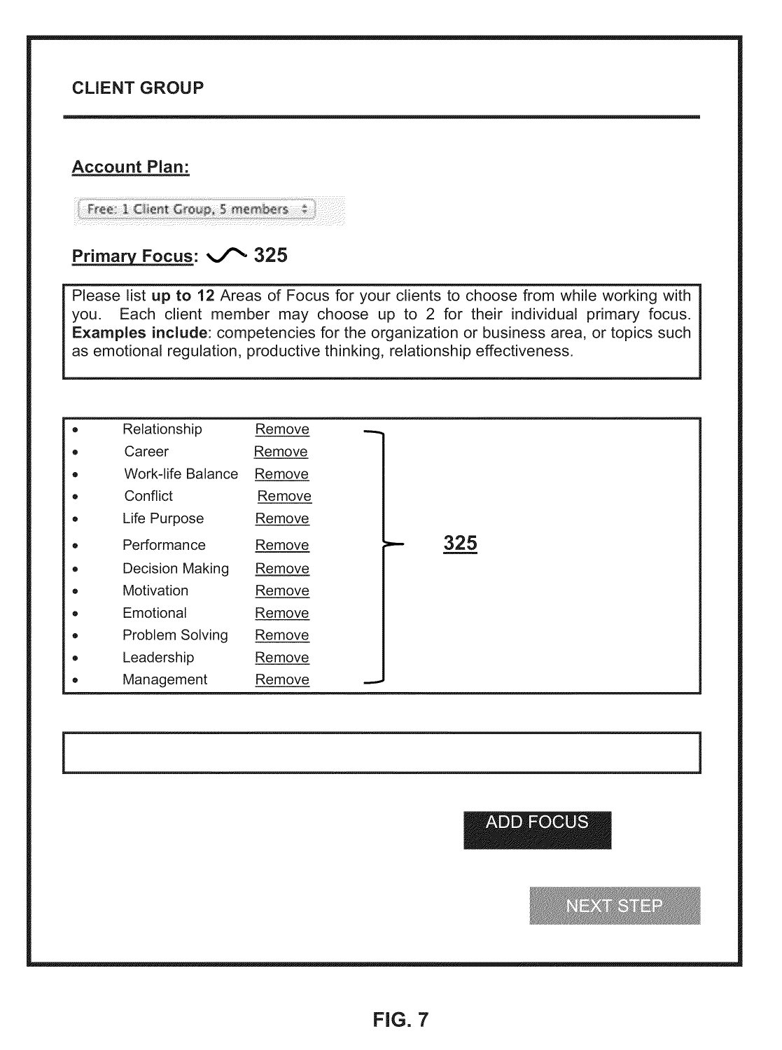

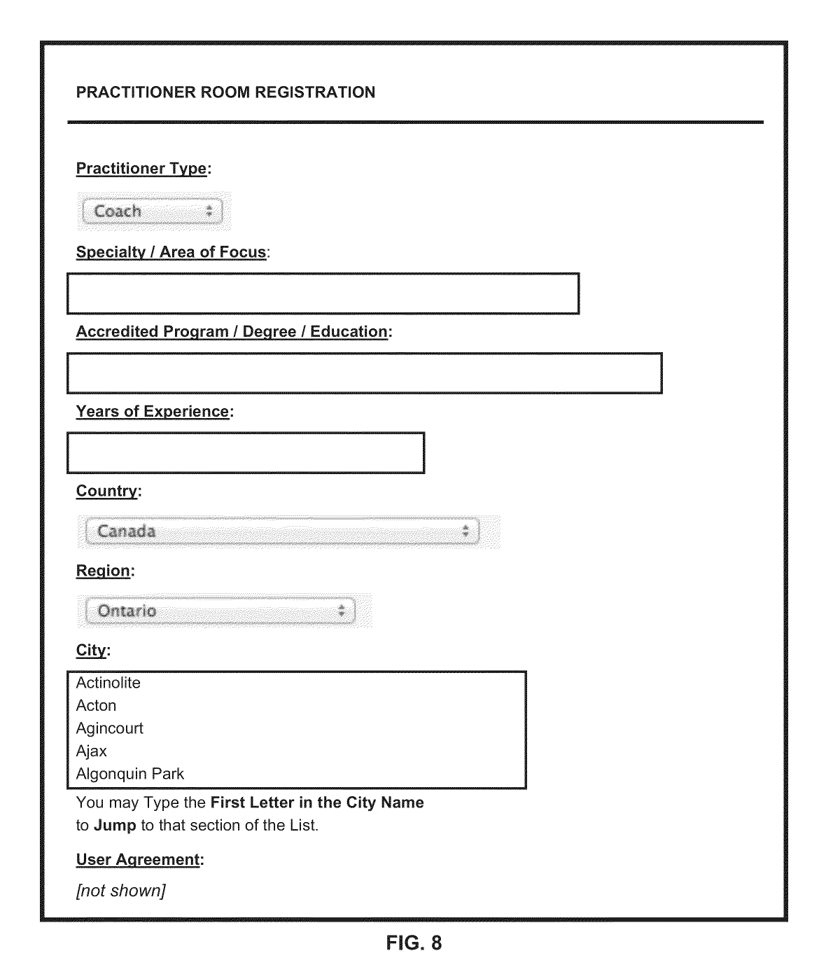

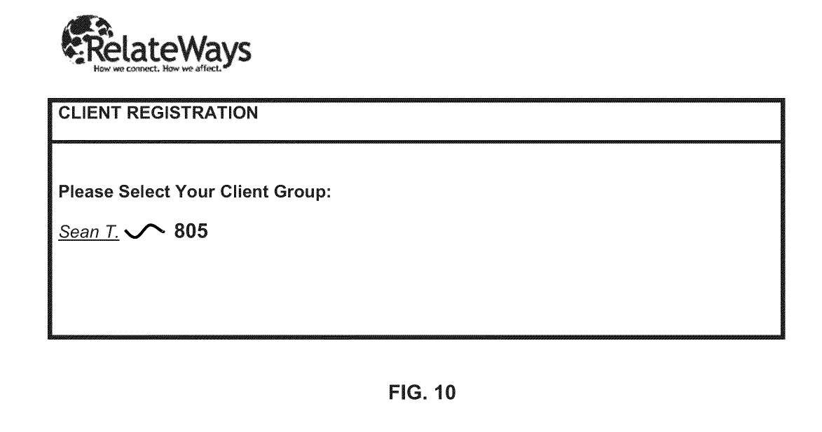

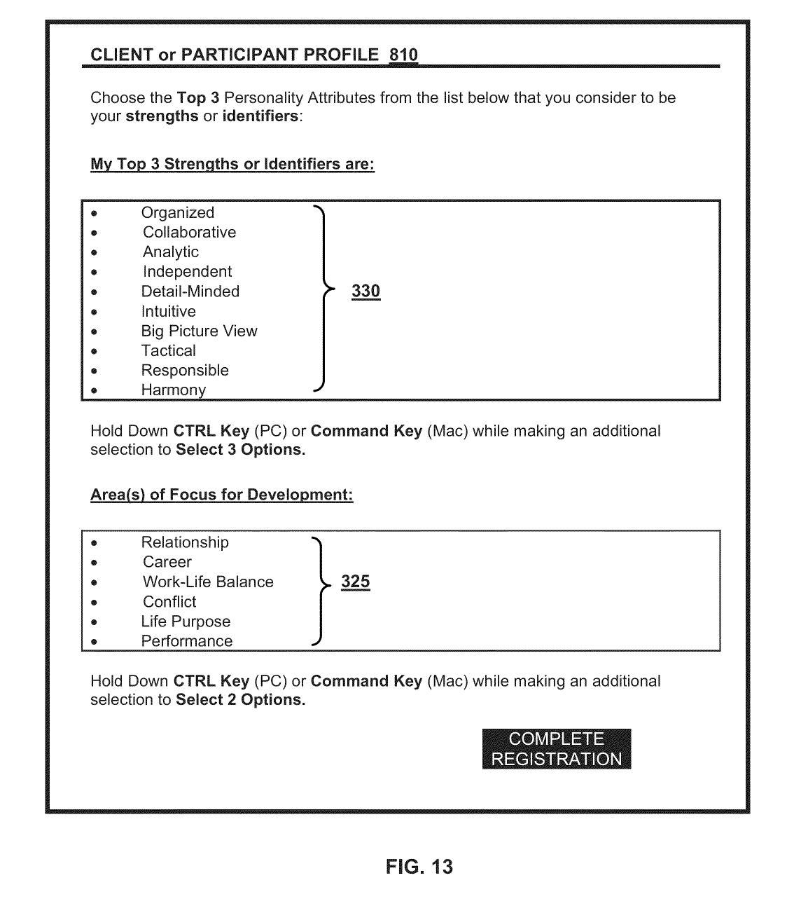

In some embodiments registration module 220 can be configured to allow and enable the various users 120, 130 of the connection platform 150 to set up a user profile including a participant profile. Registration module 220 may also be configured to send, store and retrieve all user data for a coach 120 or a participant 130 from data storage 280 or other modules. Registration module 220 may further allow the set-up of user roles, group profiles or any other user configuration data appropriate for a user. For example, for a coach or practitioner, registration module 220 be configured to take input from the user via I/O module 290, then set up a practitioner account or profile with user data such as basic information (see FIG. 6), account plan (see FIG. 7), default or custom primary focus for a client group (see FIG. 7), and other practitioner information (see FIG. 8). For a participant 130, registration module 220 can be configured to take input from user via I/O module 290, then set up a participant account or profile with user data such as client or participant group 805 (see FIG. 10), basic information (see FIGS. 3, 11 and 12), and additional participant profile data (see FIG. 13). The registration module 220 can also take care of user account authentication set up for coaches, participants, as well as system administrators.

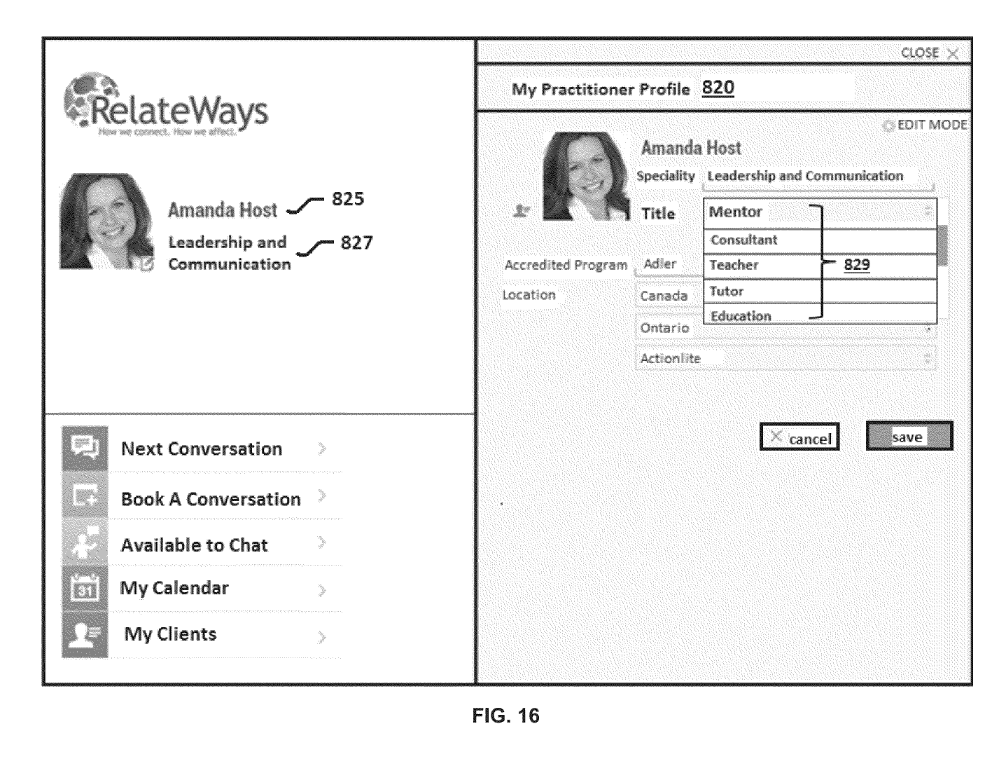

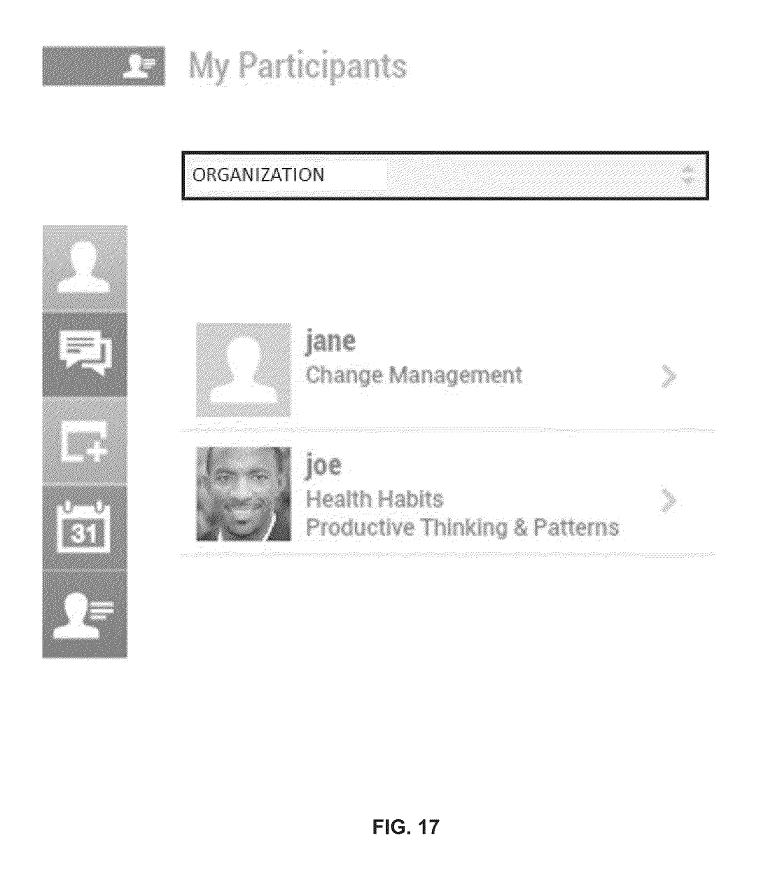

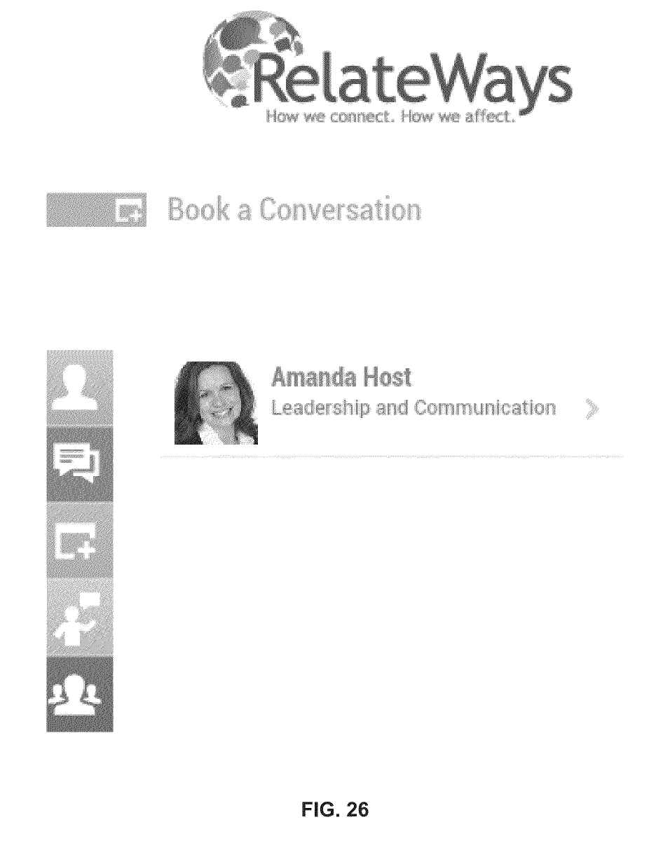

Interface module 230 can be configured to present the appropriate user interface on a coach device 120a, 120b or a participant device 130a, 130b via I/O module 290 based on a plurality of factors or options. For example, based on the device used by a coach device 120a, 120b or a participant device 130a, 130b, interface module 230 can select and present an interface that is tailored to fit the specific device, which can be for instance a mobile phone, a tablet computer, a laptop, or a desk computer. Interface module 230 can also output the appropriate user interface based on a user selection of any particular device page, such as a Practitioner Profile 820 page (see FIG. 16), a My Clients/My Participant page for a coach (see FIG. 17), or a Schedule or Book a Conversation page for a participant (see FIG. 26), to name a few.

PathWays module 240 is operable to provide a personalized PathWays Guide 300 to any participant. Conversation experiences 850 may be personalized for each individual via the Embedded Interaction Intelligence (Ell) process 370 and designed to guide people through what they want to accomplish, process, or develop. Each PathWays Guide is associated with a user (via a user identifier) and unique to the user.

PathWays module 240 may have a plurality of features implemented by hardware and/or software. For example, it may provide an interface for the Personalized PathWays Guide 300. The PathWays Guide 300 may include components, features, or elements. In one embodiment, the PathWays Guide 300 is represented by a tree structure of a plurality of data nodes such as Conversations 850, Overview 355, Path 340, Notes 350 or Reflect 360 (e.g. see FIG. 3). PathWays module 240 works with other modules in the connection platform 150 to create a personalized guide for each participant tailored to help the participant with developing their skill set or achieving a particular goal.

In one embodiment, the PathWays module 240 may include a PathWays reporting sub-module (not shown) that may generate detailed reporting data based on the data records in the electronic databases. For example, the reporting sub-module may generate reports based on who have accessed what records at what time and for how long. For another example, the reporting sub-module may determine that a certain percentage of the total number of participants has accessed, on average X (e.g. 5) days a month to view their respective PathWays Guide for 30 minutes on average.

The reporting sub-module may also generate reports on the number of participants that actively engage in conversations. There may also be provided statistic data on the number of conversations that have been scheduled or have occurred. For the conversations that have occurred, a typical or average duration of the conversations may be further determined and reported.

The reporting sub-module may further report on strengths or identifiers. For example, it may determine and display the top or bottom 3 strengths or identifiers in terms of number of selection by participants. The reporting sub-module may determine the same for motivators and values across all participant profiles.

Similarly, the reporting sub-module may determine top or bottom 3 primary focus options in terms of number of selection by participants. For example, the primary focus Productive Thinking may be the most selected primary focus. The reporting sub-module may further cross-analyze timestamps in the data records to determine when (e.g. at which months or weeks) the one or more primary focus options are selected the most in a year.

The reporting sub-module may determine a plurality of other statistics based on PathWays Guide use. For example, the reporting may determine and display intelligence statistics such as: number of users (and associated frequency) that have accessed the path 340 in the PathWays guide in a pre-determined period of time; number of users that have added or logged commitments, or next steps in a pre-determined period of time; number of commitments or next steps marked as complete within a certain period of time; number of users that have utilized progress bar in a pre-determined period of time; number of users that have toggled the Mindset Question sets a pre-determined period of time and/or in a group; the specific Mindset Question set that has been referenced the most or least often in a pre-determined period of time; and so on. All of these answers may be determined by the reporting sub-module and subsequently reported or displayed on demand.

The reporting sub-module may further determine and report on mode of communication used by the participants. For example, it may report on a list of communication tools (e.g. live conversation, recorded notes, etc.) that have been used most often by participants or supporters, and the specific points of time that such tools have been utilized (e.g. first conversation, second conversation, and so on).

It is to be appreciated that the reporting sub-module may form part of the PathWays module 240 or it may be separate from the PathWays module 240.

Conversation module 250 can be configured to look up, set up, schedule, record and provide other aspects of facilitating a conversation 850 between two or more users. In some embodiments, the conversation 850 may be guided by the Embedded Interaction Intelligence process 370. The conversation can be between a participant 130 and a coach 120, multiple participants and a coach, multiple participants and multiple coaches, participant and participant, coach and coach, or peers and participants. The coach or host of the conversation may be provided a list of Mindset Questions 342 to support the coach in the productive conversation. The list of questions 342 may be retrieved from a database with previously stored questions for use depending on the participant's goal, background, development, or other factors, which may be stored as part of the participant profile 810 or part of the PathWays Guide 300 for the participant 130. The questions may also be created or modified by a coach, a participant or an administrator in real-time and added into the database. There is a system wide default and supporters or administrators may adjust, set and save the questions per client group 805. The supporter or administrator has the ability to update the Mindset Questions at any time.

A conversation 850 may be recorded and archived for later review or download by a participant or a coach who were active or passive participants in the conversation through View Conversation History tool 362 (see e.g. FIG. 3). The conversation 850 may also be retrieved by other participants who did not engage in the conversation with the appropriate permission or security level. The permission may be given by a participant, a coach, or an administrator.

A conversation 850 is typically started by a host. The host may be a coach, or a participant. The conversation can be in the form of text, audio or video, or a combination of any of the two formats. The conversation can be limited to a specific duration, or it may keep going for unlimited amount of time, terminated only by the quitting of one or more participants.

The content of conversation 850 may be tied to a specific goal, plan, milestone, target, project, note or anything in a Personalized PathWays Guide of a participant. However, the participants may also choose to include any topic in the conversation as they see fit. The conversation may be started by a host without any specific topic in mind.

Calendar module 260 keeps track of all users' schedules, availability, or other calendar items. Calendar module 260 can be configured to store, retrieve, and manage a coach or a participant's conversation schedule or availability. Calendar module 160 may work with data storage 280 in order to store all the calendar items or schedules of all participants or users of the system 100.

A conversation calendar manager can be provided as well via calendar module 260 or conversation module 150, or both. The conversation calendar manager helps users with manage their list of scheduled conversations 830a, 830b and availability calendar, along other functions. The conversation calendar manager can send notifications to participants of a conversation ahead of the start time of a scheduled conversation 830a. The manager may further detect present or potential conflicts on a calendar belonging to any user and notify the user and/or the administrator accordingly. The manager may suggest time slots for booking a conversation or other calendar items. The manager may provide additional functionalities to integrate with a participant's native mail or calendar system on the participant's personal device.

An Embedded Interaction Intelligence module 270 may be included in the connection platform 150. The Embedded Interaction Intelligence module 270 (or simply the “EII module 270” or the “module 270”) can infuse and provide access to specific training or coaching processes and/or methodologies designed to support and guide a course of a conversation, interaction, decision, behavior modification, and so on. In one example, the module 270 may automatically populate instructional materials for a coach on his or her platform interface based on a selected process or methodology. This module provides for participants 130 to have binary capability to interact in real-time with a coach 120 and the corresponding process/methodology during audio, video and/or text conversations and have real-time interactive, customization and/or viewable capability outside of conversations. In one embodiment, the Ell module 270 implements the Embedded Interaction Intelligence process 370 on users devices to be assessed and used by participants or supporters.

In some embodiment, the Embedded Interaction Intelligence process 370 or methodology may be accredited methodologies for use in:
(a) Corporations/Workplace 372;
(b) Education 374;
(c) Health Care 376;
(d) Military 378;
(e) Customer Relation Management (CRM);
(f) Professional Coaching and Positive Psychology; and/or
(g) General public population.

One or more methodologies may be selected for the participant by the coach based on the participant profile 810 including primary foci, profession, occupation title, occupation role or any other piece of information. Once selected, the EII 270 can generate a digital framework (as part of the EII process 370) on which the participant may be guided.

For example, if a participant is in the health care industry, he may have different set of priorities and ideologies, which leads to a different mindset and framework for training. The Mindset Questions 342 thus can be tailored or customized based on the participants primary foci 325 (which may or may not be dependent on the Embedded Interaction Intelligence), as well as on an industry value set by the EII process 370 based on a selected methodology. The EII process 370 and Mindset Questions 342 can further guide the conversations 850, thinking, commitment 345, next steps 346 or decisions for the participant on his path to achieving his goal.

For another example, a EII process 370 framework may be generated if the primary focus 325 is to support smoking cessation of patients. The EII process 370 is capable of collecting and processing industry knowledge and intelligence in the database to generate the appropriate framework and to facilitate the selection of Mindset Questions 342.

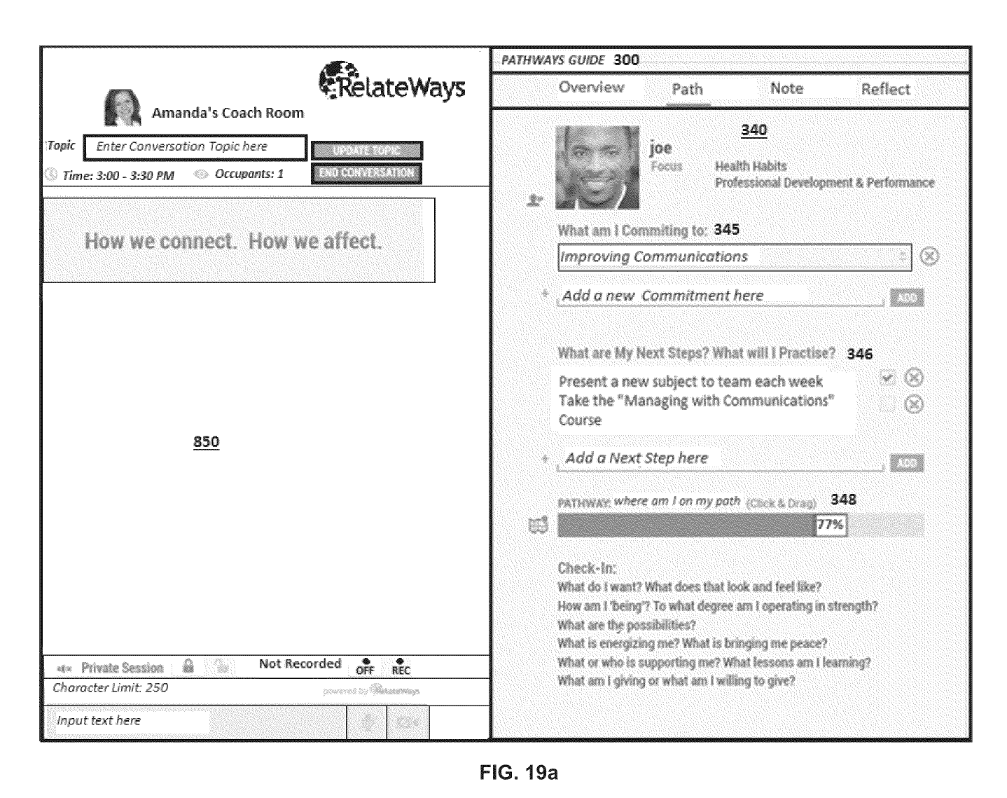

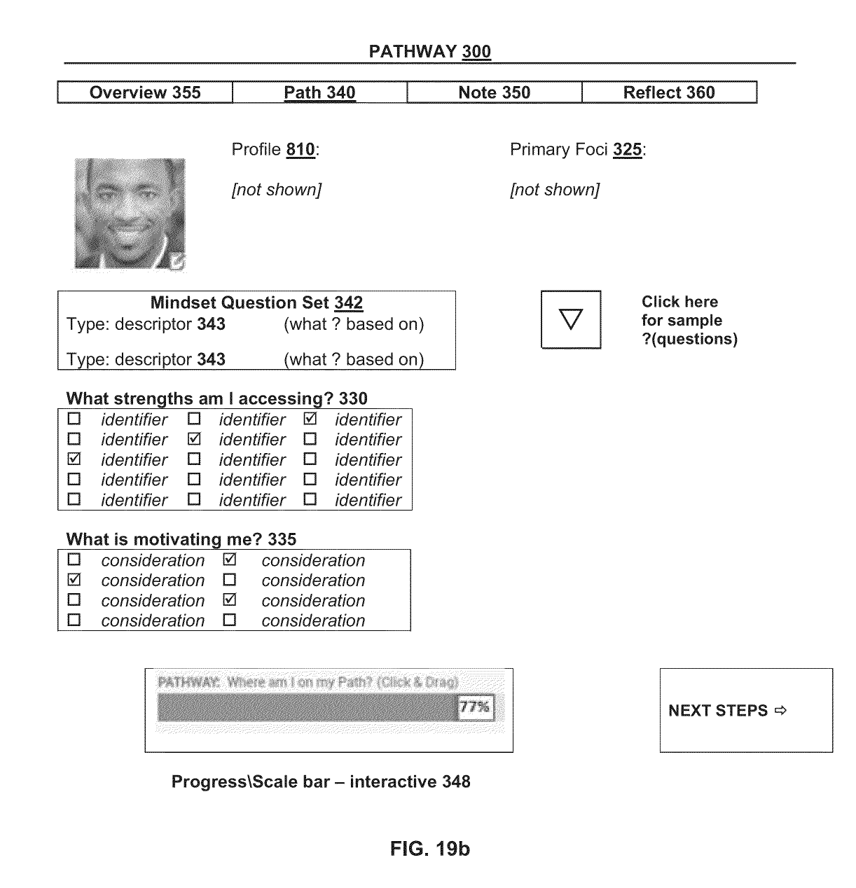

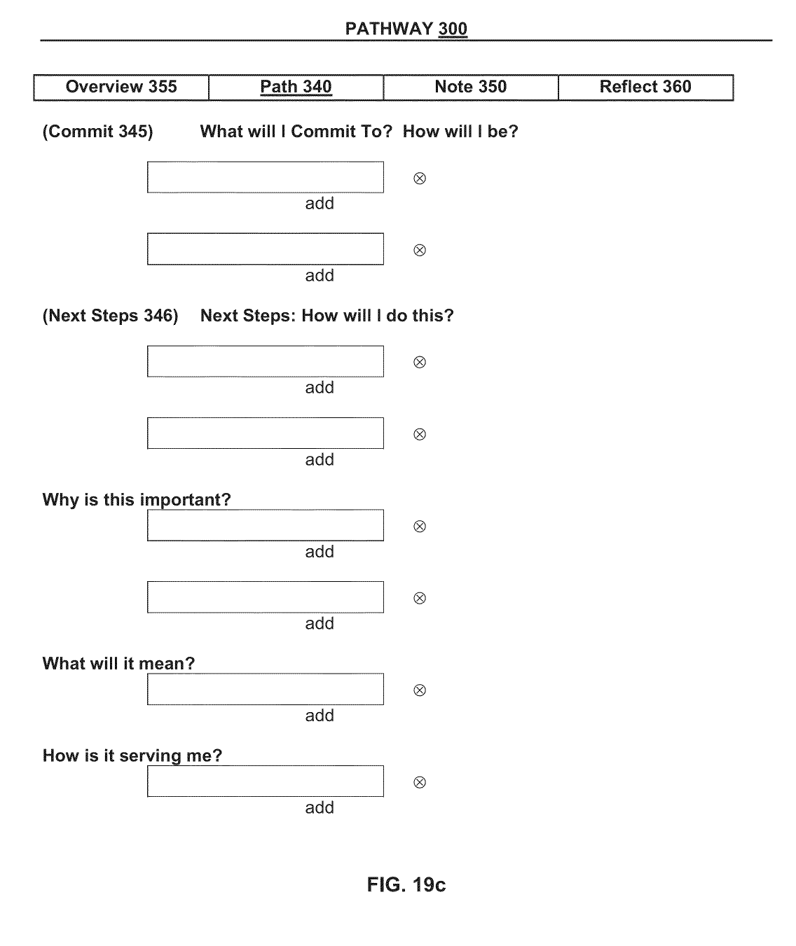

In some embodiment, each of the process or methodology may comprise at least one set of Mindset Questions 342 dependent on an industry value or one or more primary focus options 325. Each Mindset Question may comprise a type or a descriptor 343 (see e.g. FIGS. 19b and 19c). The Mindset Questions may take participants 130 through course of conversations 850, decisions, commitment 345 and next steps 346.

In another embodiment, a Peer-to-Peer module 380 may be implemented a part of platform 150. The Peer-to-Peer module 380 allows non-professional/non-practitioners to support or interact with the participants 130, access professional intelligence and the participant's PathWays Guide 300 in order to support and help the participant(s) reach their goals, which may be stored as part of the PathWays Guide 300.

Through the Peer-to-Peer module 380, each participant 130 may invite others to support or be supported via the connection platform 150.

In some embodiment, the participant 130 may further invite co-workers or managers at a workplace to support or observe him or her using an Organization Access and Support module 390 provided by the connection platform 150.

Administrative features may be further integrated with Embedded Interaction Intelligence process 370, such as availability management, booking management, PathWays reporting, observe capability, meeting capability, group management, and interaction reporting.

Binary capability and state may occur during conversation/interaction, for example, content in commit, next steps, progress bar and other ‘Path’ elements in Pathways Guide may be updated (by either coach or participant) in a binary state to allow or enhance interactions in real-time or near real-time between a coach and a participant.

Real-time or near real-time synchronization may be achieved to enable multiple parties to collaborate or converse based on the content in PathWays Guide of a participant, including real-time or near real-time changes or updates to support the conversation.

The system supports a real-time environment, so in addition to the data saving process; the real-time synchronization and collaboration ‘notifies’/displays any and all changes to both/all parities which are viewable in real-time. Co-dependency between the real-time data transfer and standard data transfer.

Referring now to FIG. 3, a Personalized PathWays Guide 300 or simply a PathWays Guide 300 for a participant may include Participant Identification record 310 that is configured to receive, modify, and store various data fields related to the participant, such as Name 312, Photo 314, Gender 316, Age or Age Range 318, Occupation, Title and Role 320, Geographic Location 322 and so on. Each of the data objects in the data record 310 may be received and updated in real-time or near real-time. The Participant Identification record 310 may form part or all of a participant profile 810.

The PathWays Guide 300 may also include up to a certain number of primary focus options 325 in data storage 280. Examples may include: competencies for the organization or business area, or topics such as emotional regulation, productive thinking, relationship effectiveness, work-life balance, and so on (see e.g. FIG. 7). The list shown is not meant to be exhaustive and is illustrative only. The primary focus options may form part or all of a participant's goals in his or her profile.

In one embodiment, as shown in FIG. 7, a coach 120 may elect up to 12 primary focus options 325 to form a default primary focus list when he or she sets up the client group 805. The coach 120 may also elects to edit an existing primary focus or to add a new primary focus to the default list for each specific client group. In this example, once the default primary focus list has been set, a client or participant 130 may only choose one or more available primary focus options 325 from the list. The list of default primary focus options 325 may include, without limitation: relationship, career, work-life balance, conflict, life purpose, performance, decision making, motivation, emotional, problem solving, leadership, and management.

In another embodiment, one or more primary focus options 325 may be selected by the connection platform 150 when the connection platform 150 receives user input from the supporter or coach. Supporters may identify and set a list of up to a pre-determined number of primary focus options (e.g. 12 options) in the categories of competencies, skills, values, strengths, strategies, and so on. In one example embodiment, these options may be stored on database 280.

In still another embodiment, the connection platform 150 may by default choose one or more primary foci 325 for the participant 130 based on a number of factors, such as Embedded Interaction Intelligence 370 options or values, participant's goals, profile data, or personality strengths 330.

In yet another embodiment, individual participants may select their own primary focus 325 or may customize their own options through the connection platform 150. The participants 130 can select up to a pre-determined number of primary foci (e.g. 2 primary foci) which are stored in the PathWays Guide 300 and displayed for the participant's future reference. The supporter 120 can in real-time or near real-time view the participant's primary focus options 325 in order to keep the conversation on course. The primary foci may be logged for reporting purposes on at least two occasions: a) each conversation and b) when the primary focus options are modified by either party.

It is to be appreciated that the default primary focus 325 options may be set by the coach 120 alone, or set by the coach 120 with assistance or intelligence from Embedded Interaction Intelligence process 370, which provides a vehicle for integrating industry values, ideologies or other industry intelligence into the PathWays Guide 300.

Personality strengths or identifiers 330 may also be part of the PathWays Guide 300. In some example embodiments, the personality strengths or identifiers 300 may include motivators 335 and values.

Mindset Questions 342 as stored on the electronic database 140 can be part of PATH 340, which records and displays the electronic journey the participant is taking to achieve his or her goals. A list of Mindset Questions 342 may contain a specific sequence of questions; each of the questions may contain a type or descriptor 343. The Mindset Questions may take participants 130 through course of conversations 850, decisions, commitment 345 and next steps 346. In some embodiments, the list of Mindset Questions 342 may form as a portion of the Embedded Interaction Intelligence Process and Guide 370.

It is to be appreciated that the default or initial Mindset Questions 342 options may be set by the coach 120 alone, or set by the coach 120 with assistance or intelligence from Ell process 370, which provides a vehicle for integrating industry values, ideologies or other industry intelligence into the PathWays Guide 300.

The coach or host of the conversation may be provided a list of Mindset Questions 342 to support the coach in the productive conversation. The list of questions 342 may be retrieved from a database with previously stored questions for use depending on the participant's goal, background, development, or other factors. The questions may also be created or modified by supporters 120, participants 130 or system administrators where settings permit.

In some example embodiment, there may be a default set of Mindset Questions 342 for all participants until further customization, which may be done by supporters 120 or administrators, who can adjust, set and save the questions per participant or per group of participants. In some embodiment, only a supporter 120 or a system administrator may update or modify the set of Mindset Questions associated with a participant profile; in other cases, a participant 130 himself may be able to revise or update the Mindset Questions 342. In some embodiment, the participant 130 may answer some of the Mindset Questions, and the answers may cause the supporter 120 or the connection platform 150 to update the Mindset Questions 342 in real-time or near real-time.

In an example embodiment, each of the Mindset Questions has an associated type or descriptor 343 (see e.g. FIG. 19b). In addition, the Mindset Questions are in sequence and inter-related to support the conversation and decision/thinking process between a participant 130 and a supporter 120. The Mindset Questions 342 may take participants 130 through course of conversations 850, decisions, commitment 345 and next steps 346.

There may be a data analytics utility to generate useful intelligence the connection platform 150 may use to modify the Mindset Questions. For example, as shown in FIG. 19b, if the set of Mindset Questions 342 does not fit the circumstance for the participant, the participant 130 may click a button, which allows the Mindset Question types to be rotated into view. The participant 130 may decide on a more suitable list of Mindset Questions 342 accordingly. The Mindset Questions 342 are sequenced and are built-in with inter-relation intelligence to integrate industry values and ideologies with a participant's profession and primary foci. In some embodiments, if and when a participant 130 wishes to log or answer the Mindset Questions 342, they may do so. Various types of response and interactions may be generated and sent to the participant 130 based on his or her answers. The most recent set of Mindset Questions and/or question set descriptors can be sent to participants 130 with a conversation reminder to prompt them and allow them to ‘Think it Through’ and log or note down the thoughts before a scheduled conversation (also known as “next conversation”) 830a with a supporter 120.

As shown in FIG. 19c, PATH 340 may further include Commitments (or “commit”) 345, which may comprise Steps or Next Steps 346 and Progress bar 348. In some embodiments, next steps 346 and progress bar 348 may be separate entities from commitment 345. The commitments 345 can be next steps 346 and future progress expected of the participant 130, as set by the participant 130 or alternatively, by the connection platform 150 based on the primary foci 325 and Mindset Questions 342.

Private notes (or “notes”) 350 may form part of the PathWays Guide 300. The notes may be entered by both participants 130 and supporters 120, and may be shared, where permitted, with other people such as peer supporters.

Reflect module 360 may form part of the PathWays Guide 300. The Reflect module 360 may allow a participant 130 or a supporter 120 to view conversation history 362 or an update history of participant's profile or PathWays Guide 300.

As previously describe, Embedded Interaction Intelligence module 370 may include training or coaching process or methodology for use in:
(a) Corporations/Workplace 372;
(b) Education 374;
(c) Health Care 376;
(d) Military 378; and/or
(e) CRM (not shown).

Peer-to-Peer Support 380 may form part of the PathWays Guide 300. In some embodiment, there may be provided a single log-in capability, which may be implemented with features that allow participants to invite others to support them (or be a member of their sounding board) and vice versa. Participants 130 and supporters 120 may also accept similar invitations where available. The Peer-to-Peer module 380 allows non-professional/non-practitioners to support or interact with the participants 130, access professional intelligence and the participant's PathWays Guide 300 in order to support and help the participant(s) reach their goals. Through the Peer-to-Peer module 380, each participant 130 may invite others to support or be supported via the connection platform 150.

Organization Access and Support 390 may form part of the PathWays Guide 300. For example, the participant 130 may invite co-workers or managers at a workplace to support or observe him or her using the Organization Access and Support module 390 provided by the connection platform 150. The employer organization may also access the participant's profile without explicit permission from the participant, in order to monitor and record the participant's progress.

General Public Access and Support module 375 may form part of the PathWays Guide 300. The general public, through a device, may access the connection platform 150 and the PathWays Guide 300 upon invitation by an existing participant device or a coach device. Alternatively, the general public may sign up for a user account or profile without any invitation.

The system 100 can support a real-time or near real-time environment. Data modification or input may be received, synchronized and recorded in real-time or near real-time, as such, collaboration and/or all changes to both/all parities may be viewable in real-time or near real-time. Co-dependency between the real-time data transfer and standard data transfer.

In one example embodiment, the connection platform 150 includes notifications features where supporters 120 are notified of a participant's 130 completed commitment 345, which may be accessed via the participant 130's PathWays Guide 300. Also, both participant 130 may be notified when there has been a certain delay period between conversations or access. Organizations may also opt for a notification that prompts participants 130 when it is time to book another conversation.

In one example embodiment, a participant 130 may register for RelateWays™ Platform and PathWays Guide 300 via register module 220. At the time of registration, he may select a coach or supporter 120. The participant 130 can proceed to filing out basic information in a participant profile 810. The supporter 120 may be notified of this new participant, and prompted to review his or her profile. The supporter 120 may next chooses 12 primary focus options 325 for the participant, either based on default system settings, or based on custom selections by the supporter 120 or by the participant 130. The supporter 120 has the power and tools to overwrite any default setting as well as any participant primary focus options. In some embodiments, the supporter 120 may have a specific set of primary focus options 325 for a particular group of participants 130. The primary focus options then form part of the PathWays Guide 300 for the participant 130, which helps to steer all conversations between the participant and other users of the system 100. The participant 130 or the supporter 120 may modify the primary focus options 325 any time, either during an active conversation or outside of a conversation. Based on the primary focus options 325, at least one set or one type of Mindset Questions may be automatically populated by the connection platform 150, for example, by Ell process 370.

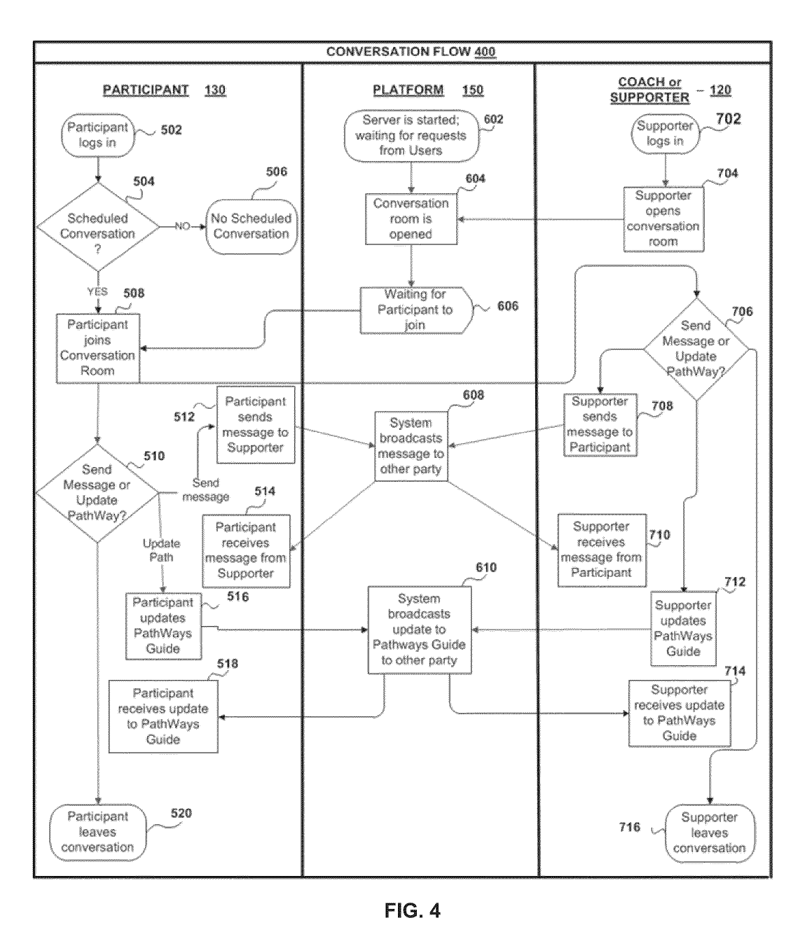

Referring now to FIG. 4, a sample flowchart of a conversation flow 400 is provided in accordance with some example embodiments. As can be seen, a server is started for the connection platform 150 at step 602, at which point the connection platform 150 waits for requests from users. Once a Supporter or coach logs in at step 702 and opens a conversation room at step 704, a conversation room is opened at step 604. At this point, the coach may wait for the participant to join the conversation at step 606. A Participant 130 can first logs in at step 502, then checks to see if a there is an upcoming scheduled conversation 830a at step 504. If there is no scheduled conversation 830a, the conversation flow may stop at step 506, or the participant 130 may join a new conversation if the conversation room is open at step 606. At step 508, if and when there is an active conversation 850 between the participant and another person, the participant may send a message or update PathWays Guide at steps 510 and 706 during a conversation. A supporter or coach 120, at the same time, may also send a message or update Pathways Guide at step 706. If and when a participant 130 updates the PathWays Guide 300 at step 516, or when a supporter 120 updates the PathWays Guide 300 at step 712, the connection platform 150 broadcasts the update to the PathWays guide and may alert the other party regarding such update at step 610.

Furthermore, when a participant and supporter exchanges messages at steps 512, 514, 708, 710, the connection platform 150 can be configured to broadcast message to the other party at step 608.

At steps 520 and 716, the conversation has ended when both or all devices belonging to the parties have left (e.g. disconnected from) the virtual conversation room.

The conversation record, including any updates to the PathWays Guide 300, can be recorded in database 280 for future retrieval and reference.

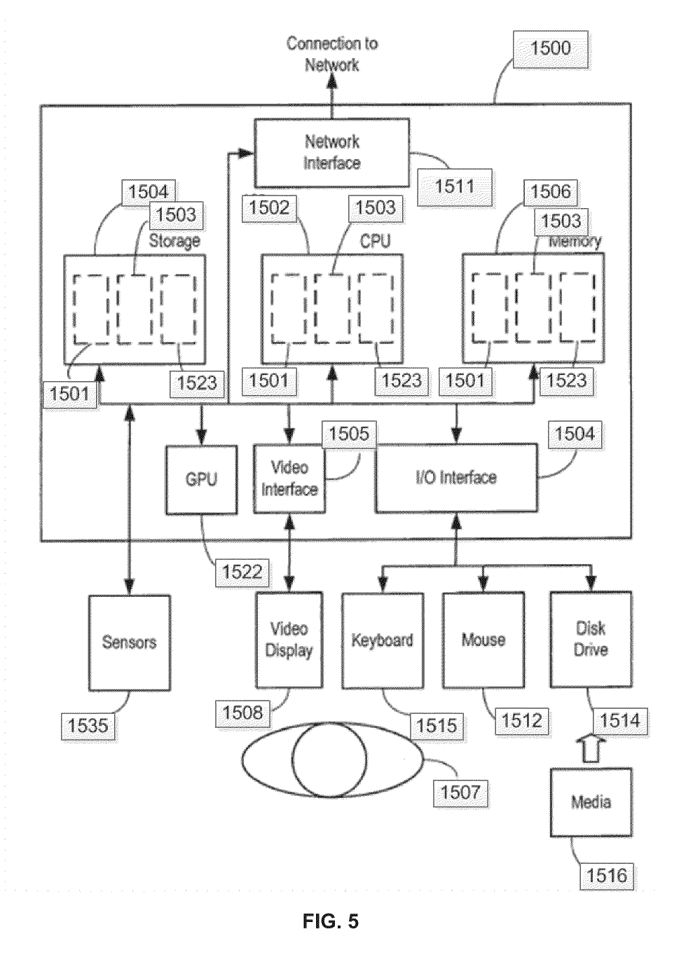

By way of example, FIG. 5 shows a computer device 1500 that may include a central processing unit (“CPU”) 1502 connected to a storage unit 1504 and to a random access memory 1506. The CPU 1502 may process an operating system 1501, application program 1503, and data 1523. The operating system 1501, application program 1503, and data 1523 may be stored in storage unit 1504 and loaded into memory 1506, as may be required. Computer device 1500 may further include a graphics processing unit (GPU) 1522 which is operatively connected to CPU 1502 and to memory 1506 to offload intensive image processing calculations from CPU 1502 and run these calculations in parallel with CPU 1502. An operator 1507 may interact with the computer device 1500 using a video display 1508 connected by a video interface 1505, and various input/output devices such as a keyboard 1515, mouse 1512, and disk drive or solid state drive 1514 connected by an I/O interface 1509. In known manner, the mouse 1512 may be configured to control movement of a cursor in the video display 1508, and to operate various graphical user interface (GUI) controls appearing in the video display 1508 with a mouse button. The disk drive or solid state drive 1514 may be configured to accept computer readable media 1516. The computer device 1500 may form part of a network via a network interface 1511, allowing the computer device V00 to communicate with other suitably configured data processing systems (not shown). One or more different types of sensors 1535 may be used to receive input from various sources.

FIG. 6 is a sample user interface of a practitioner registration page for a connection platform 150 according to some embodiments. As can be seen, a coach or a practitioner may sign up for use of the connection platform 150 (one example of the system 100 embedding a connection platform 150) online at an URL. The registration page may be accessed anywhere remotely or at a local work station. The registration page asks for basic information such as (but not limited to) Name of Business or Private Practice, Administrator's First Name, Administrator's Last Name, Gender, Contact Phone Number, Email Address, Confirm Email Address, Password, and Confirm Password. Some of the above listed fields may be mandatory and some may be optional. Once all mandatory fields have been filled, the user may click on “Next Step” to proceed to the next registration page.

FIG. 7 is another user interface of a practitioner registration page for a connection platform according to some embodiments. At this page, the coach is asked to select an Account Plan for a client or participant group. For example, the coach may select “Free: 1 Client Group, 5 Members.” Other options may include, for example, “$50 per year, 2 Client Groups, 20 Members” or any appropriate account plan. The coach is also asked to select a primary focus. The coach may list up to 12 areas of primary focus 325 for his or her clients or participants to choose from while working with the coach. Each participant may choose up to 2 areas of primary foci for their individual primary focus. Examples include: competencies for the organization or business area, or topics such as emotional regulation, productive thinking, relationship effectiveness, work-life balance, and etc. The list shown is not meant to be exhaustive and is illustrative only.

FIG. 8 is yet another user interface of a practitioner registration page for a connection platform according to some embodiments. On this page the coach selects or inputs additional user information such as a practitioner type (e.g. “coach”), a specialty or area of focus, an accredited program/degree/education, years of experience, country, region, city, etc. The list shown is not meant to be exhaustive and is illustrative only.

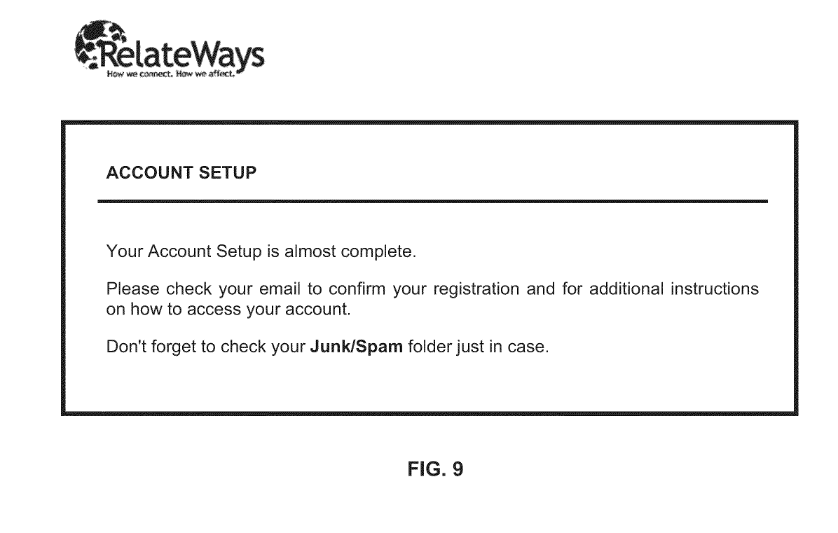

FIG. 9 is a user interface of a practitioner account setup notification page for a connection platform according to some embodiments. This page indicates that the practitioner has given enough information to have a basic account set up. Additional step may be required and the user should check his or her email for additional instructions on how to access the account.

There may be a number of ways for a client (or a group member) to register. In one exemplary embodiment, the coach or practitioner may control and initiate the account set-up process for each group member. This way the coach or practitioner, or the sponsor organization, may manage the group or participant base effectively. For instance, once a coach or practitioner has registered as a host, a confirmation e-mail can be sent to the registered e-mail account of the coach or practitioner; the e-mail may contain a host account URL. The host account URL may link to a host landing page. The coach or practitioner may then send this host account URL to other people, allowing them to register, via the host landing page, as a group member or a participant belonging to the particular group of which the coach or practitioner is also a member.

In another embodiment, each participant or user may initiate the account set-up process without a host account URL. In this case, the user may invite their ‘Personal Council’ (coach, mentor, peer, friend, and so on) to register by entering the e-mail address of each ‘Personal Council’ the user wishes to invite.

In yet another embodiment, there may be a single registration/log-in process where an individual may set up both a host and participant profile in one single event, which can be initiated by either side. This can reside in a “public offering’ template and provide a more open environment.

FIG. 10 is a user interface of a participant registration page for a connection platform according to some embodiments. This page asks the participant to select a client/participant group 805. The page, though not shown, may ask the client to select multiple client/participant groups.

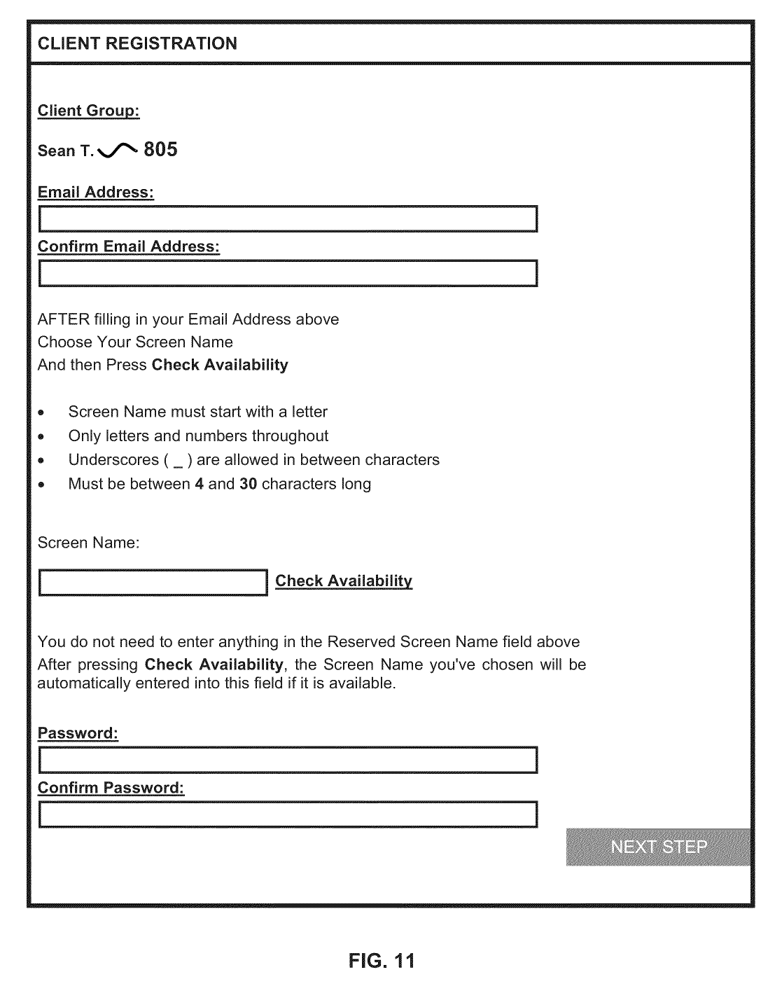

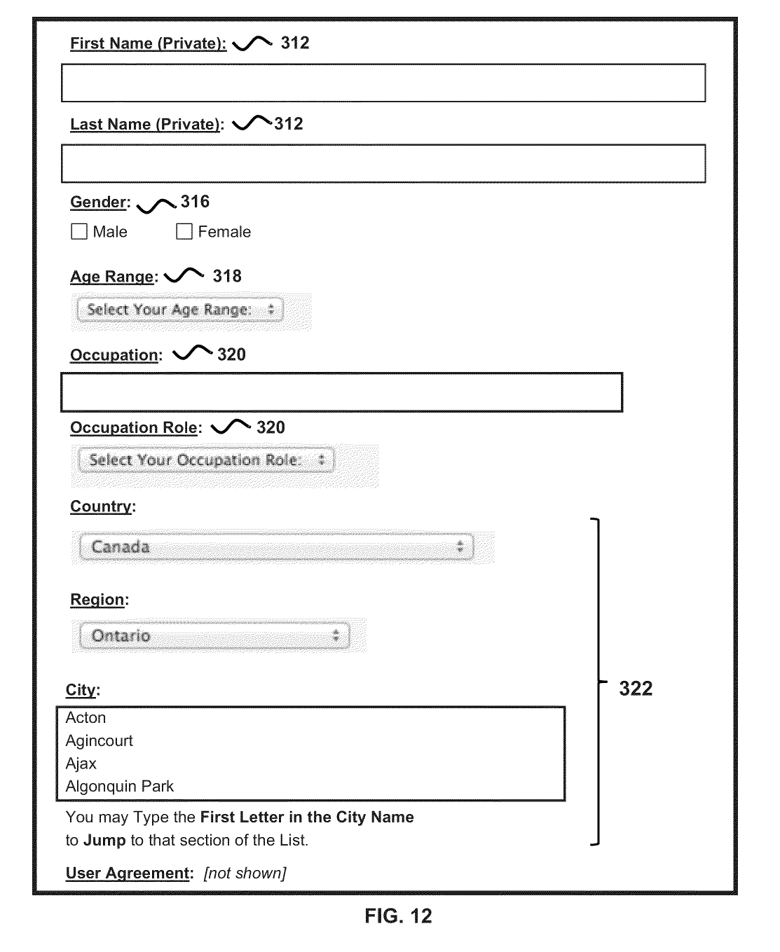

FIGS. 11 and 12 illustrates a user interface of a participant registration page for a connection platform according to some embodiments. This page asks for additional client information such as email address, screen name, first and last name 312, gender 316, age range 318, occupation information including title and role 320, geographical address information 322. The list shown is not meant to be exhaustive and is illustrative only. FIG. 12 is a continuation of FIG. 11.

FIG. 13 is a user interface of a participant registration page prompting user to enter additional registration data for a participant profile 810 as provided by a connection platform according to some embodiments. At this page, the client is prompted to enter top three personality attributes that are considered to be his or her strengths or identifiers 330, such as Organized, Collaborative, Analytic, Independent, Detail-minded, Intuitive, Big Picture View, Tactical, Responsible and Harmony. The list shown is not meant to be exhaustive. The participant 130 may further select up to two areas of primary focus options 325, as shown.

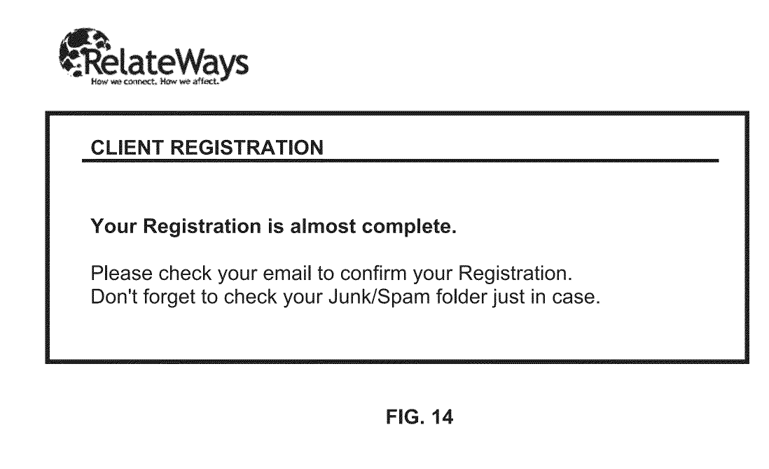

FIG. 14 is a user interface of a participant setup notification page for a connection platform according to some embodiments. This page indicates that the participant has given enough information to have a basic account set up. Additional step may be required and the user should check his or her email for additional instructions on how to confirm or access the account.

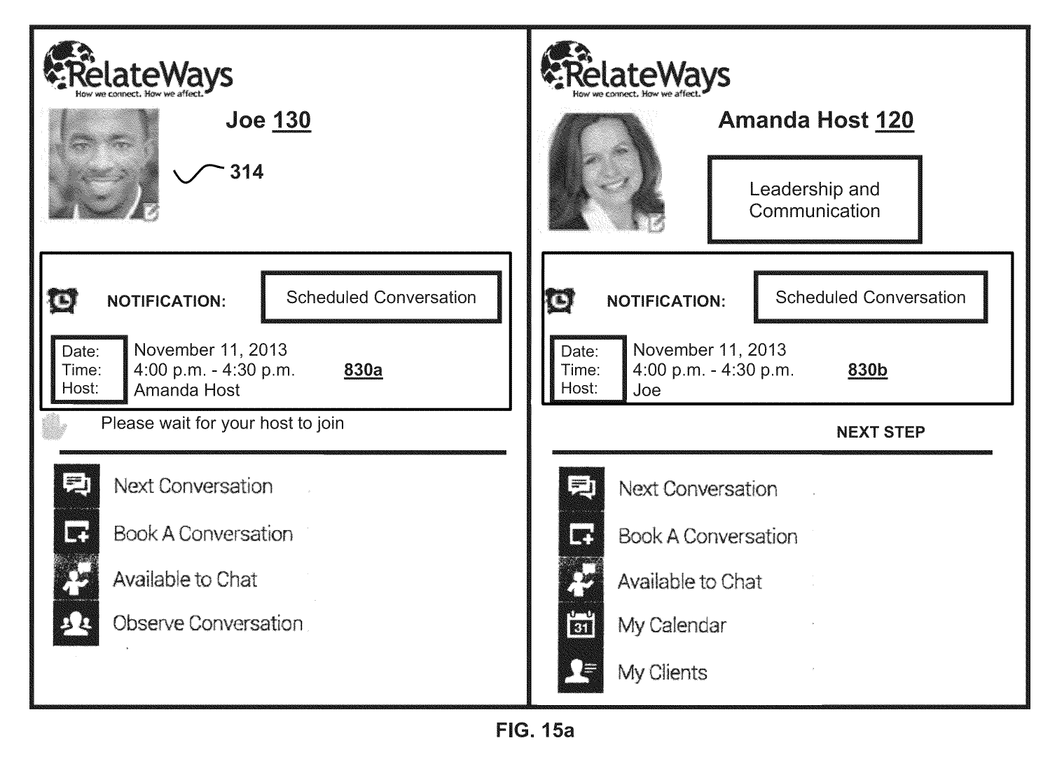

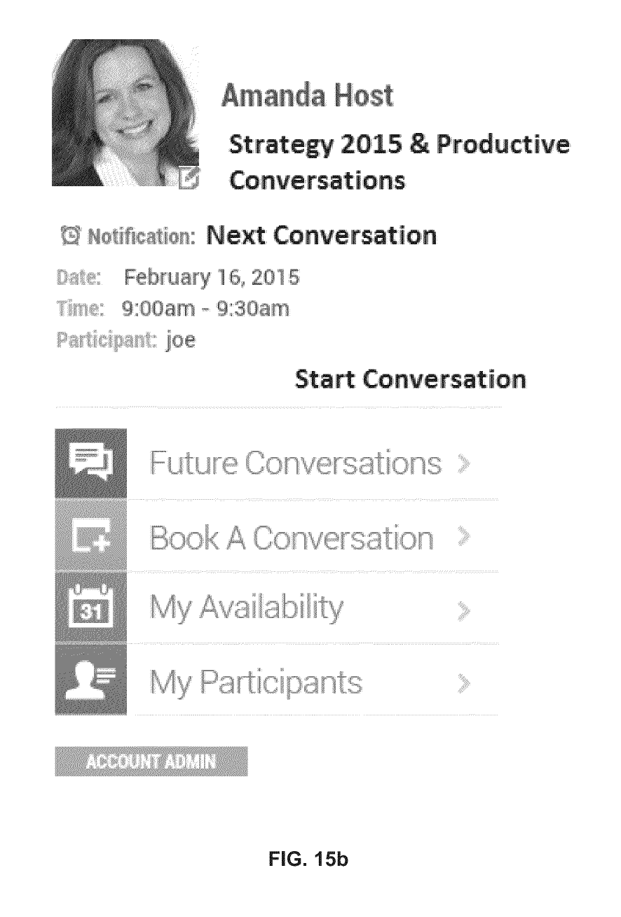

FIGS. 15a and 15b show various user interfaces of a participant interface and a coach interface provided by a connection platform 150 according to some embodiments. As can be seen, Joe is a participant, his interface shows upcoming scheduled conversations 830a under a notification banner. For example, one upcoming conversation is with Amanda Host, a coach. Joe is asked to wait for his host to join the conversation before starting the conversation session. Beneath the notification component, there are at least four tabs or options: Next Conversation, Book A Conversation, Available to Chat, and Observe Conversation, which will be further elaborated below. The list shown is not meant to be exhaustive and is illustrative only.

Amanda is shown to have the role of a coach, or a host. Her interface also shows upcoming scheduled conversations 830b under a notification banner; for example, in this case her scheduled conversation with Joe is shown. She has the option to start the session on time, ahead, or late. Beneath the notification component, there are at least four tabs or options: Next Conversation, Book A Conversation, Available to Chat, My Calendar, and My Clients. The list shown is not meant to be exhaustive and is illustrative only.

FIG. 16 is a user interface showing a Practitioner Profile 820 of a coach provided by a connection platform 150 according to some embodiments. As can be seen, the coach or host may have the ability to choose their “profession” or “title”. This may enable additional customization of coach profile and may provide for a multitude of sponsors/hosts to support individuals and groups. In this user interface, Amanda Host is the Name 825 of the coach or practitioner with a practitioner profile 820. Her Specialty is Leadership and Communication 827. She may also enter additional information such as Title 829.

Next Conversation or Future Conversations can include a list of upcoming scheduled conversations 830a, 830b, as retrieved from the database, for a participant 130 or coach 120.

Book a Conversation is a tool that enables the participant 130 or the coach 120 to book a conversation with another user of the connection platform 150, such as another participant 130, another coach 120, a peer, a manager and so on.

Available to Chat or My Availability is a tool that enables a participant 130 or a coach 120 to display his or her availabilities for chats or conversations with another user of the system.

My Calendar is a tool that enables a participant 130 or a coach 120 to show his or her calendar.

My Clients or My Participants (see e.g. FIG. 17) on a coach 120's profile allows the coach to access his or her client list, or to configure access to the client list for other users of the system.

FIG. 17 illustrates a user interface showing a participant list for a coach provided by a connection platform according to some embodiments; This page shows the “My Client” page of a coach, if the “My Client” or “My Participants” tab in FIG. 15a, 15b or 16 is selected.

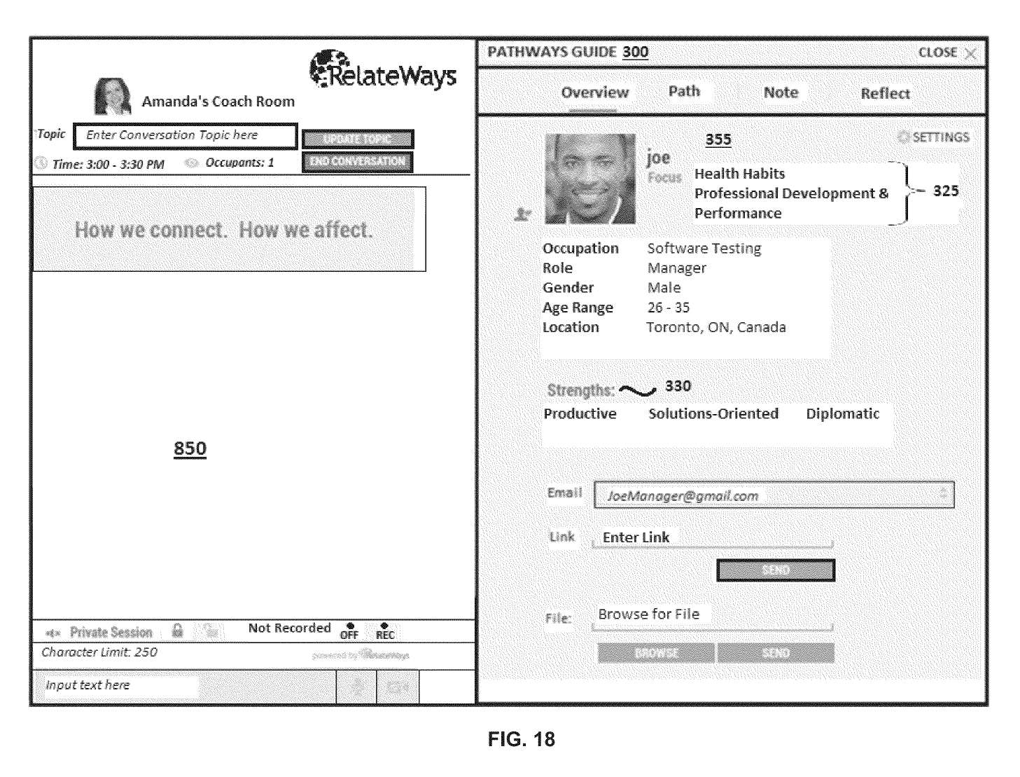

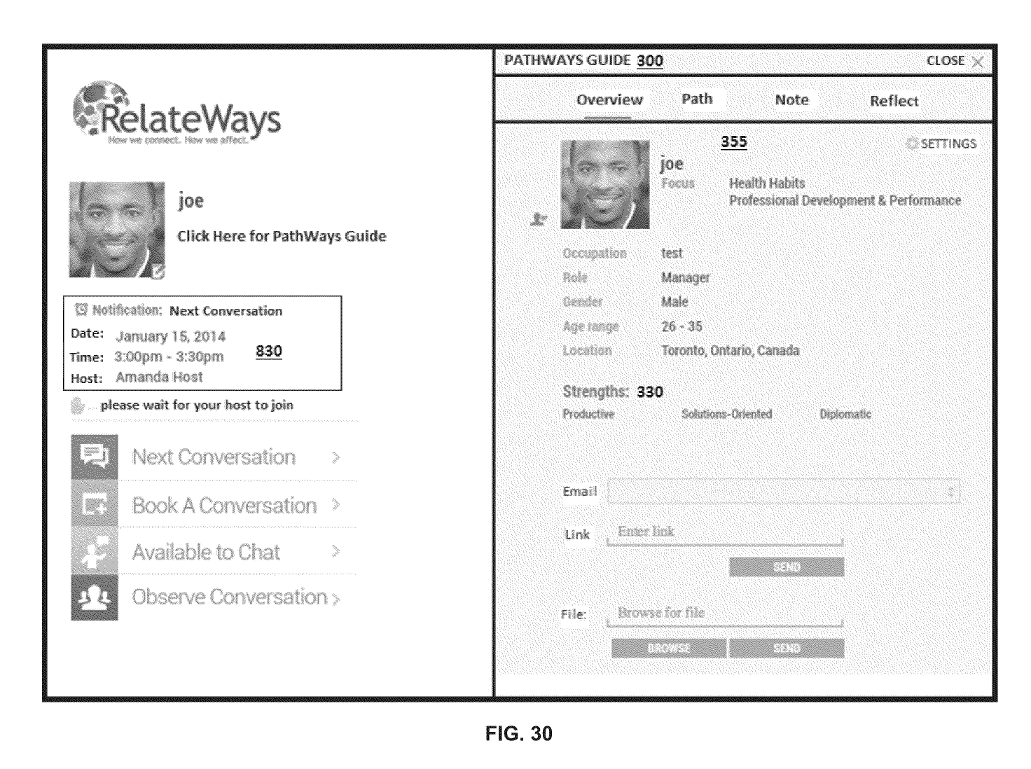

FIGS. 18 and 30 each illustrates a user interface showing an overview section 355 of a PathWays Guide 300 which may be displayed for the coach or the participant as provided by a connection platform according to some embodiments. As can be seen, in FIG. 18, a live conversation 850 may be ongoing in a chat room alongside the overview section 355. The conversation may be a private session and may be recorded by audio or video. In FIG. 30, a scheduled conversation 830 page is shown alongside the overview section 355 of the PathWays Guide 300.

Joe in this example is Amanda's participant in a Client Group 805. The Overview may be part of a participant's Personalized PathWays Guide 300 or simply a standalone page. Amanda, as a coach to the Client Group 805, is given permission to access and view a participant's Personalized PathWays Guide including Overview 355, Path 340, Note 350 and Reflect 360 sections. Notes that the Client Group 805 may be optional, such that Amanda and Joe may still engage and have conversations without belonging to any Client Group 805. In addition, Amanda may see Joe's PathWays Guide 300 while she is having a conversation 850 with Joe. The PathWays Guide 300 provides a great amount of information of a participant to a coach as he or she tries to help the participant with an workplace issue, project goal, process or any other topic. For example, strengths or identifiers 330 of the participant may be displayed to the coach. The Primary Foci 325 of the participant may also be displayed. This way, the coach is not simply just “chatting” with the participant. Instead, the coach can tailor or target a specific topic or area and better help the participant with his or her concerns, since the coach can see the strengths, weakness, personal goal(s), occupation, age, gender, or any other information regarding the participant. The Personalized PathWays Guide 300 can also be available to the coach or the participant in the absence of active conversations 850.

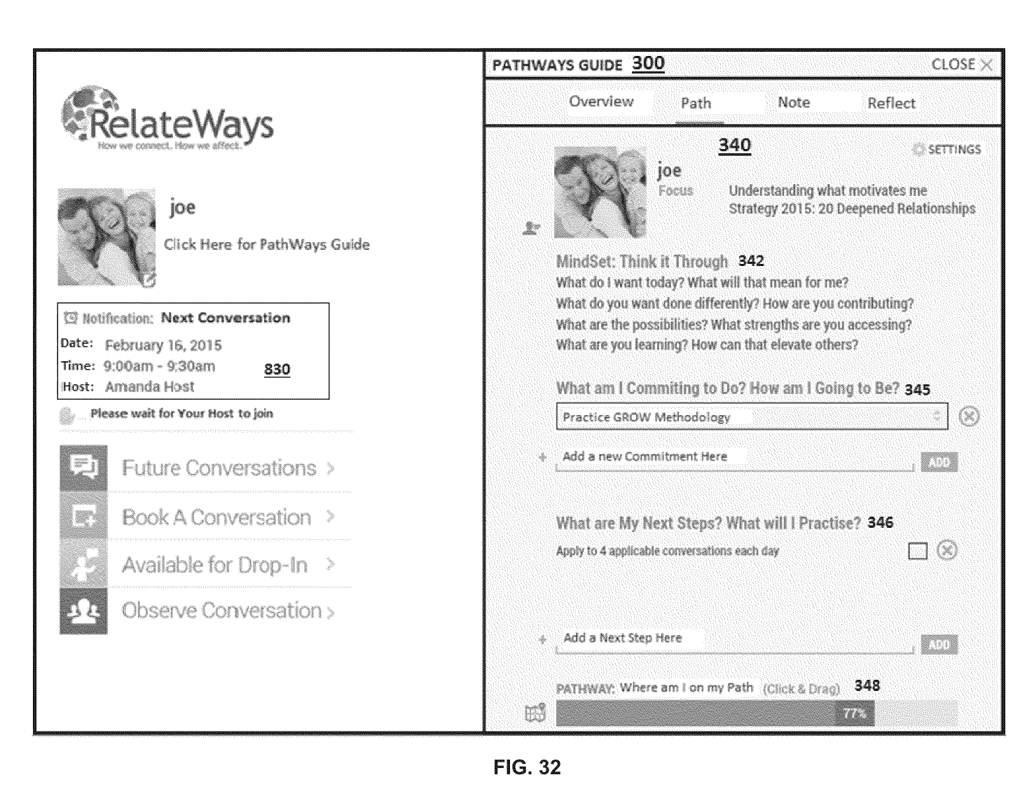

FIGS. 19a and 32 each illustrates a user interface showing a Path 340 of a participant which may be displayed to a coach or the participant as provided by a connection platform according to some embodiments. The Path 340 may be part of a participant's Personalized PathWays Guide 300 or simply a standalone page. The Path 340 shows various options such as “Cancelled”, “In Progress”, “Completed” for each goal, action, or plan item listed. The Path 340 may be initially set up by a participant when the participant registers for an account, or it may be set up over the course of using connection platform 150. In addition, the Path 340 may include Primary Foci 325, Mindset Questions 342, Commitments 345, Next Steps 346, and a Progress Bar 348. Again, both the coach and the participant may see the Path 340 whether they are having an active conversation 850 or not.

As shown in FIGS. 19a and 32, the path section 340 may further include and display primary focus options 325 of the participant, a Mindset Question set 342, a commitment section 345, a next steps section 346 as well as a progress bar 348.

As can be seen, in FIG. 19a, a live conversation 850 may be ongoing in a chat room alongside the path section 340. The conversation may be a private session and may be recorded by audio or video. In FIG. 32, a scheduled conversation 830 page is shown alongside the path section 340 of the PathWays Guide 300.

FIGS. 19b and 19c illustrate an alternative view of the Path section 340 of a PathWays Guide 300 for a participant 130. As can be seen, the Path 340 may include a participant profile 810, primary foci 325, Mindset Question set 342 including a type or descriptor 343, a roll-down or drop-down list for rotating through the question sets, strengths or identifiers 330, motivators 335, a progress bar 348, commitment 345, next steps 346, and other considerations such as why is this important, what will it mean, and how is it serving me (i.e., the participant). The strengths or identifiers 330 as well the motivators 335 can be checked based on information provided by the participant at registration or last use, and continuously updated or edited during or outside of conversations 850.

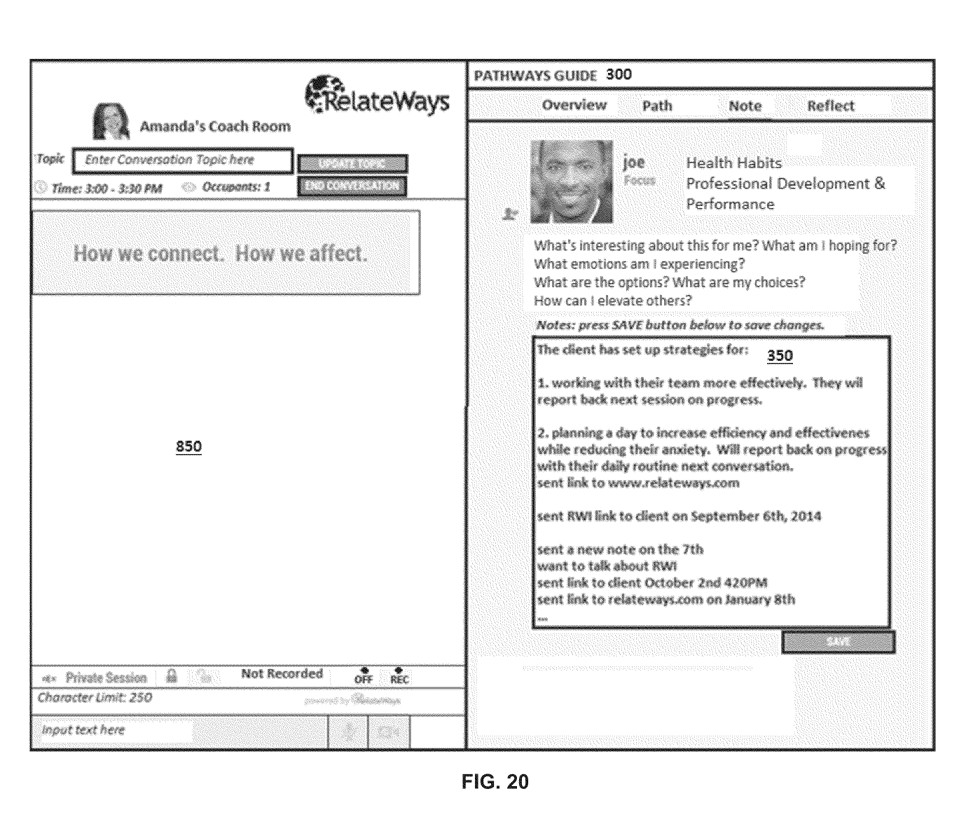

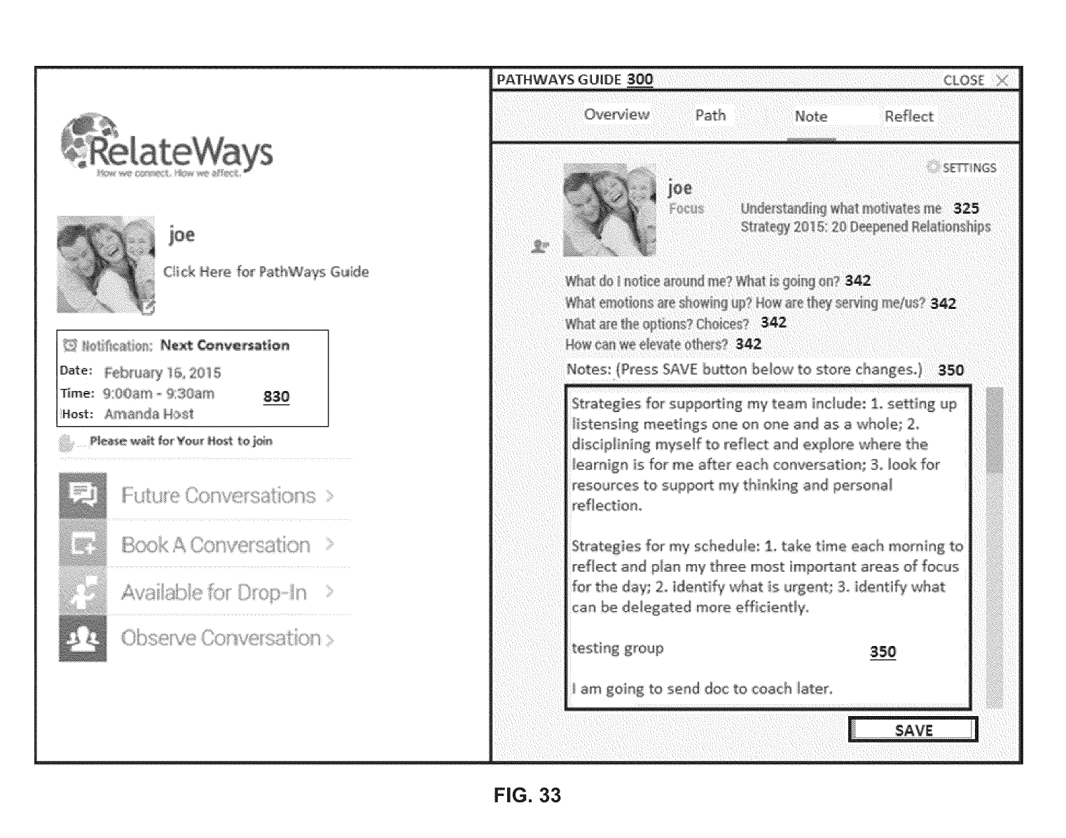

FIGS. 20 and 33 each illustrates a user interface showing a Note section of a Personalized PathWays Guide 300 which may be displayed to a coach or the participant as provided by a connection platform according to some embodiments. The Note section may include Mindset Questions 342 to guide the participant along his path of reflection and note-taking. In a text box provided by the Note section, both the coach and the participant may be able to enter, delete, or edit notes 350. Again, both the coach and the participant may see the Note section whether they are having an active conversation 850 or not.

In FIG. 33, primary focus options 325 and Mindset Questions 342 are displayed on top of private notes 350 recorded.

As can be seen, in FIG. 20, a live conversation 850 may be ongoing in a chat room alongside the note section. The conversation may be a private session and may be recorded by audio or video. In FIG. 33, a scheduled conversation 830 page is shown alongside the note section of the PathWays Guide 300.

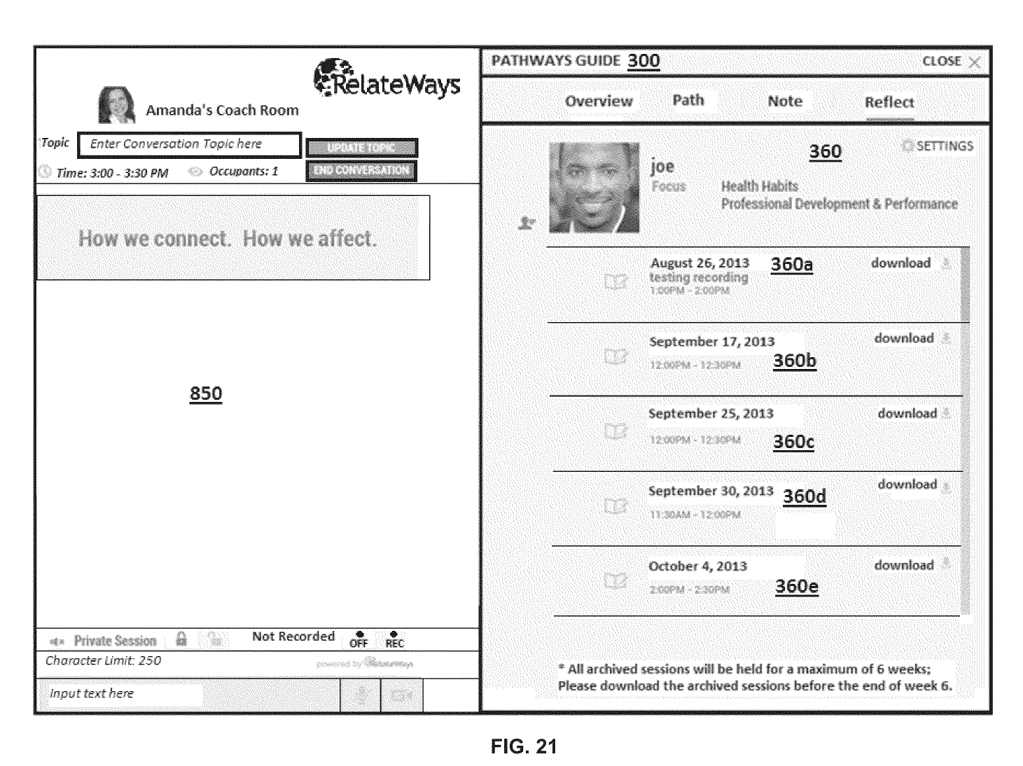

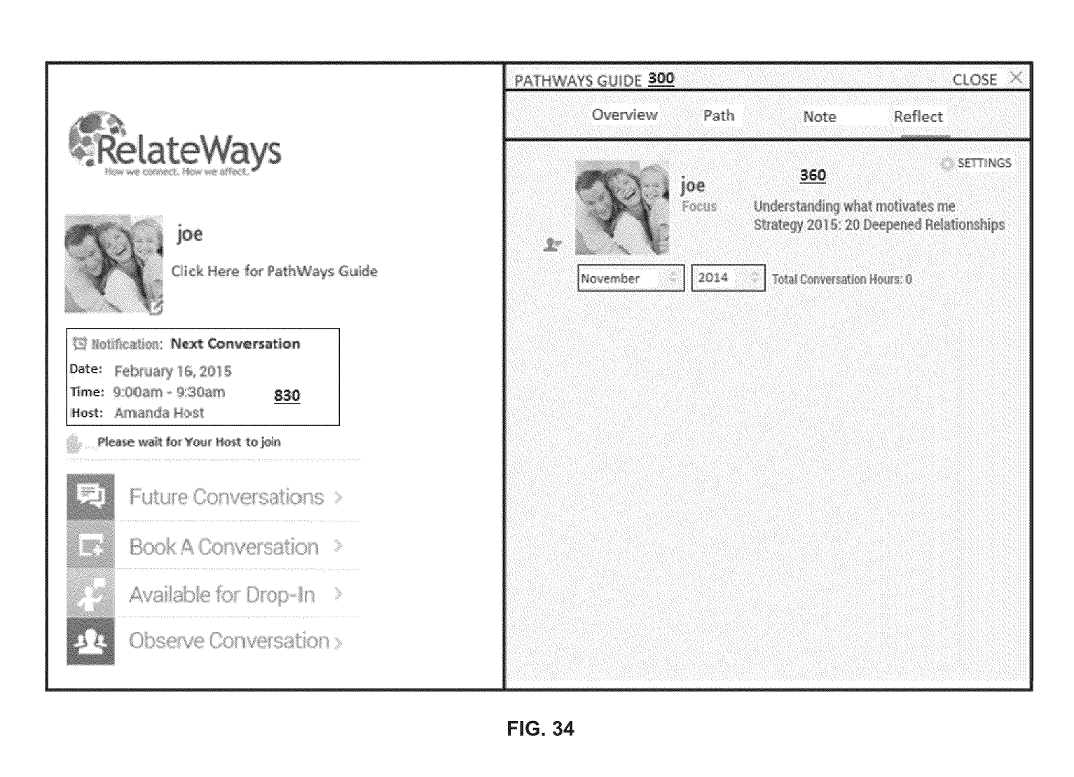

FIGS. 21 and 34 each illustrates a user interface showing a Reflect 360 or archive section of a Personalized PathWays Guide 300 for a participant Joe which may be displayed to a coach the participant as provided by a connection platform according to some embodiments. The Reflect section 360 may be part of a participant's Personalized PathWays Guide or simply a standalone page. The Reflect 360 section can provide records of past conversations 360a-390e in any format, including text, audio or video. These conversations may be viewed or streamed online, or downloaded. Again, both the coach and the participant may see and download conversations from the Reflect 360 section whether they are having an active conversation 850 or not. The archived conversations may have a pre-determined expire date, though they may also be available for an unlimited time, as determined by an administrator.

As can be seen, in FIG. 21, a live conversation 850 may be ongoing in a chat room alongside the reflect section 360. The conversation may be a private session and may be recorded by audio or video. In FIG. 34, a scheduled conversation 830 page is shown alongside the reflect section 360 of the PathWays Guide 300.

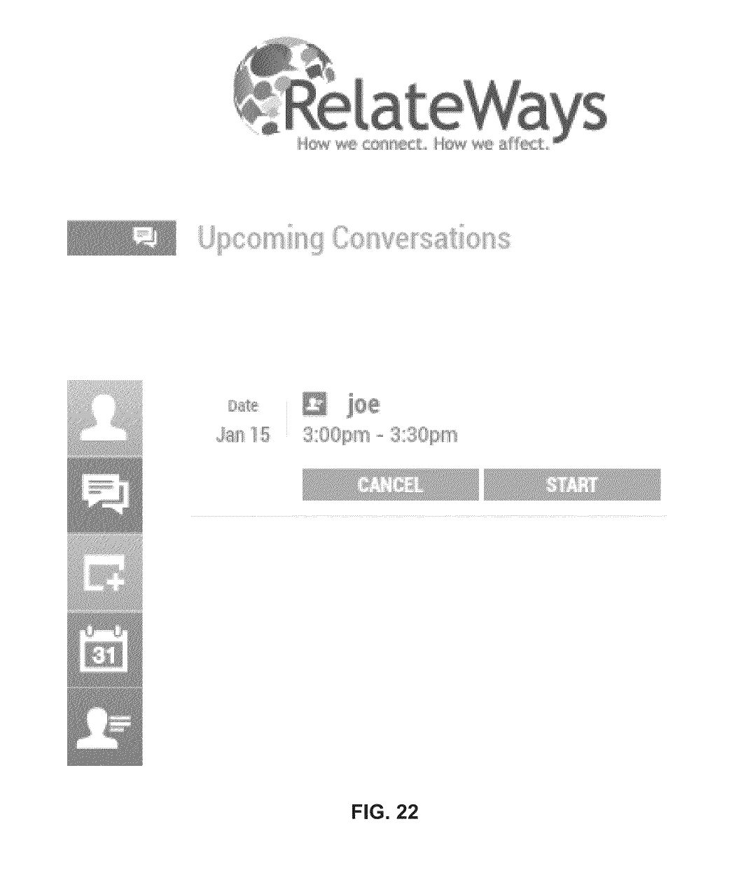

FIG. 22 is a user interface of a list of upcoming conversations for a coach provided by a connection platform according to some embodiments. The list shows that Amanda has an upcoming conversation with Joe, a participant, at 3-3:30 PM on January 15^{th}.

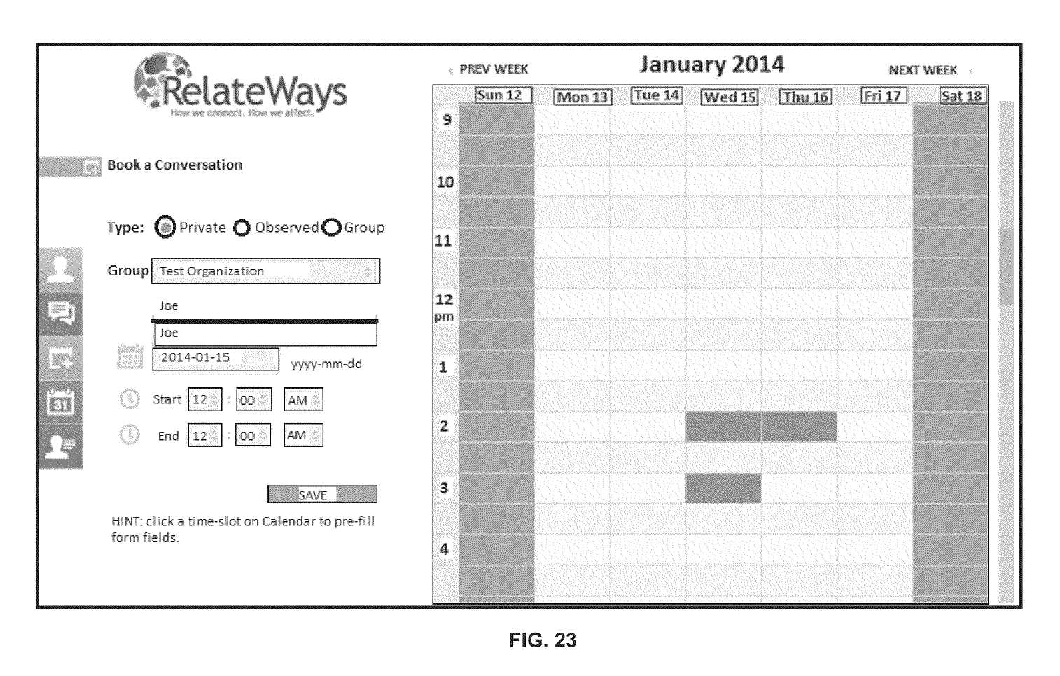

FIG. 23 is a user interface of Book a Conversation tool by a coach provided by a connection platform according to some embodiments. A coach is able to schedule any number of conversation(s) using this page. The calendar shows the availability of a coach. The calendar may also show the availability of other participants in the conversation as selected by the coach.

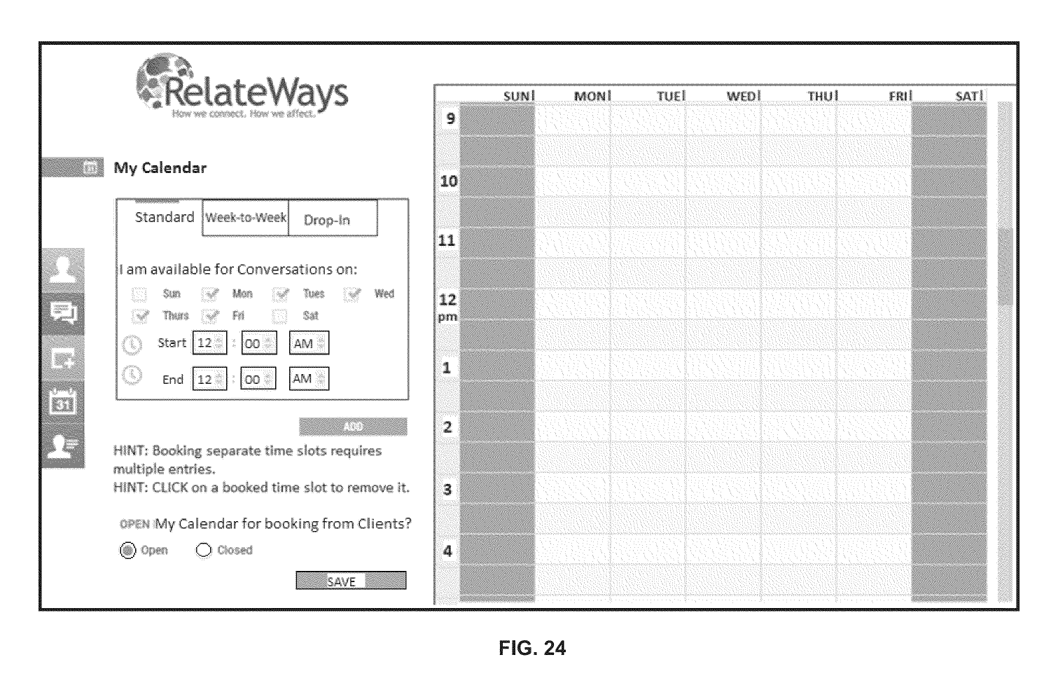

FIG. 24 is user interface of My Calendar tool for a coach provided by a connection platform according to some embodiments. Other than scheduling conversations, a coach can also specify the time frames during which he or she is available for a chat, and have such availability information accessible to other users of the system. This way, if a participant wishes to schedule a conversation with a coach, he or she may be able to quickly determine if a particular time slot is good for the coach or not.

In addition, the My Calendar view can show the availability of a coach in a Standard or Week-to-Week view. A coach can modify his or her schedule by adding or removing availability for sessions. The coach also has the option to open “My Calendar” for scheduling from participants: if “Open” is selected by the coach, then participants can view the coach's availability as reflected in the coach's “My Calendar” and send scheduling or appointment requests based on the coach's availability; if “Closed” is selected by the coach, then his or her availability information in “My Calendar” may not be viewable or accessible to the participants.

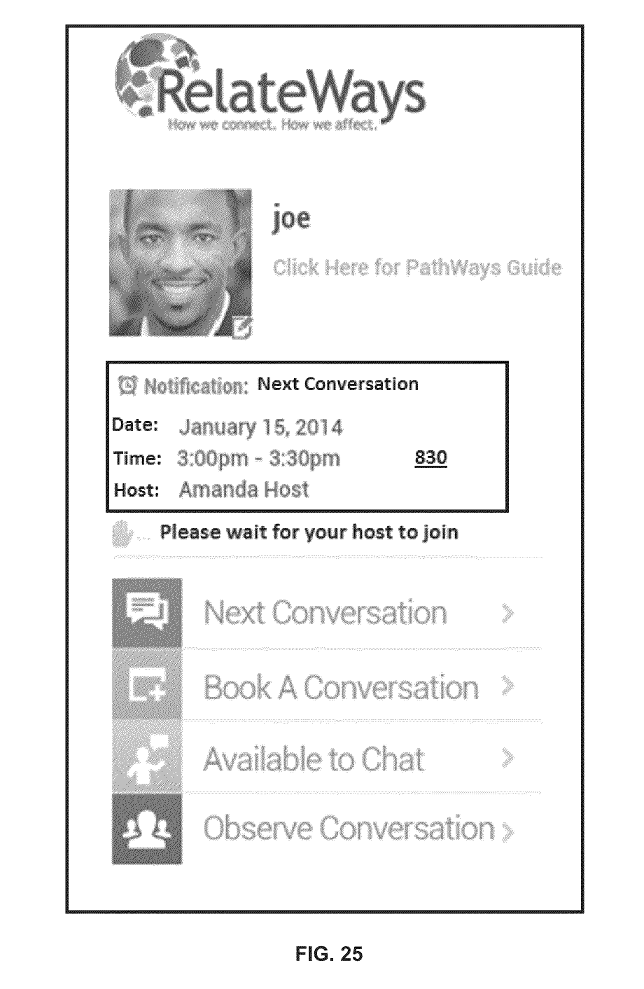

FIG. 25 is a user interface of a participant interface provided by a connection platform according to some embodiments. This interface also shows upcoming scheduled conversations 830 under a notification banner; for example, in this case the participant Joe's scheduled conversation with Host Amanda is shown. Underneath the notification component, there are at least four tabs or options: Next Conversation, Book A Conversation, Available to Chat, My Calendar, and My Clients. The list shown is not meant to be exhaustive and is illustrative only.

FIG. 26 is a user interface of conversation scheduling by a participant provided by a connection platform according to some embodiments. This user interfaces shows that Amanda Host is available as a coach to be booked for a conversation. In other embodiments, friends, family members, peers and managers may also be booked for conversations.

In addition, in another embodiment, friends, family members, peers and managers may be invited as peer supporters to help the participant with his or her learning process. The invited peer supporters may access the PathWays Guide 300 based on the privacy settings of the participant. The privacy settings may be set by default, a system administrator, a coach or the participant himself. The peer supporters may be invited for conversations, chats, viewing of the notes and participant profiles and so on.

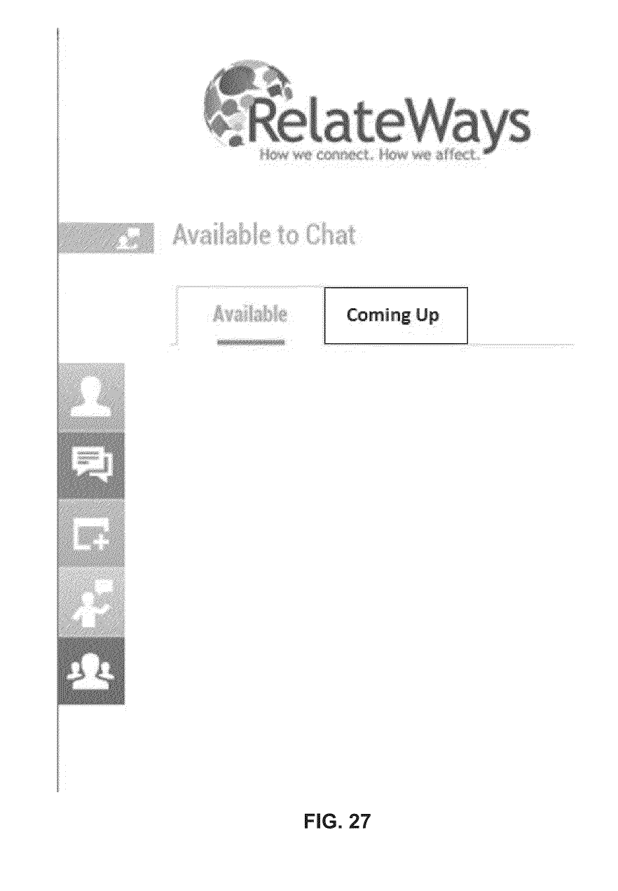

FIG. 27 is a user interface of list of people available to chart which may be displayed as output for a participant provided by a connection platform according to some embodiments. In this instance, there is nobody available to chat.

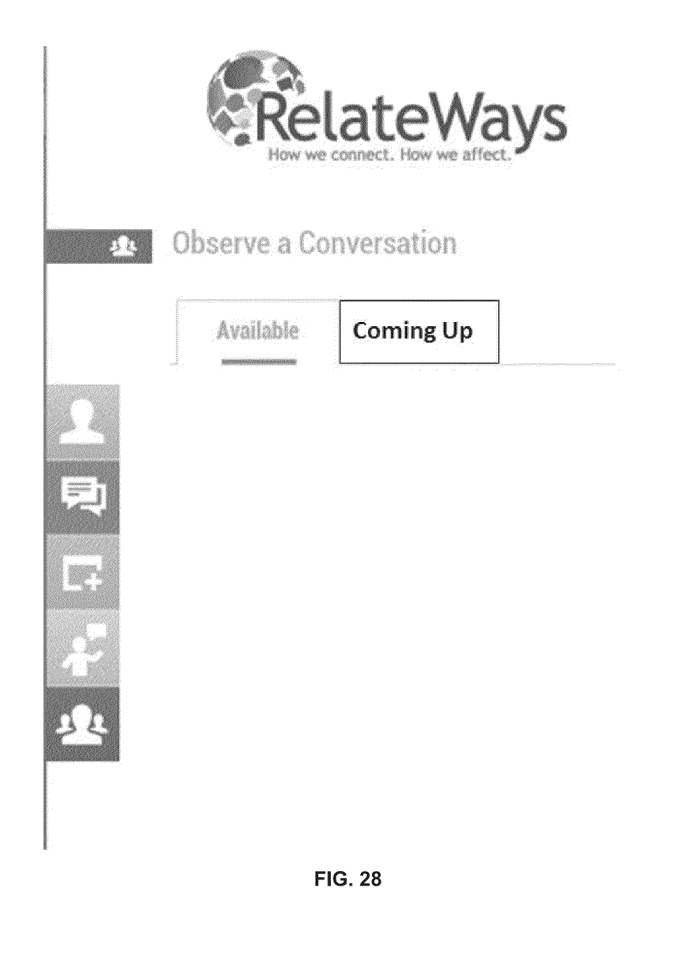

FIG. 28 is a user interface of list of available conversations to observe which may be displayed as output for a participant provided by a connection platform according to some embodiments. In this instance, there is conversations that the participant may observe.

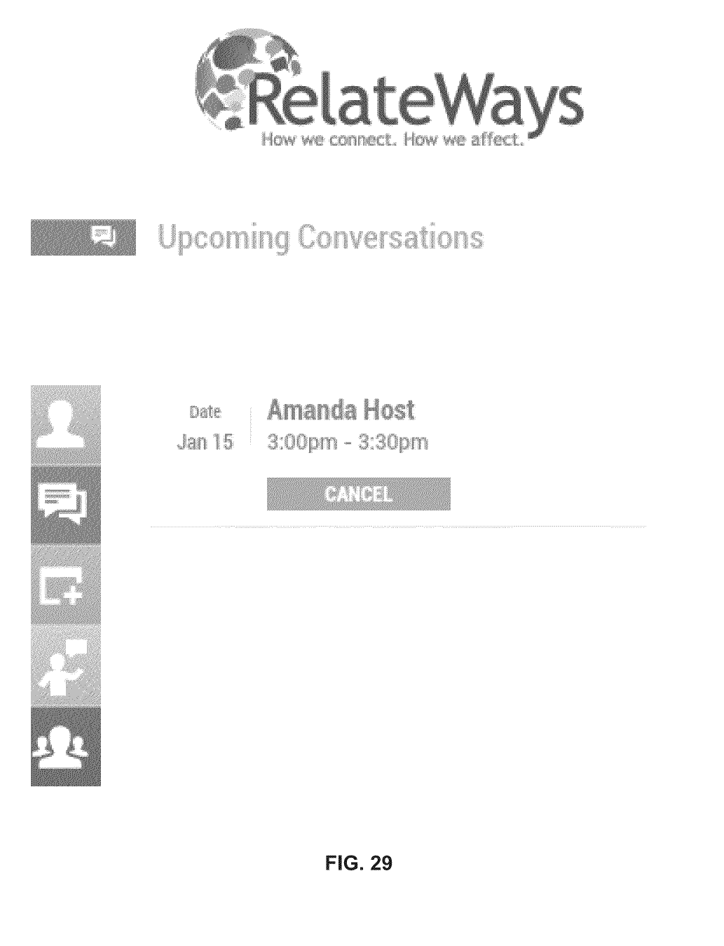

FIG. 29 illustrates a user interface of Upcoming Conversations for a participant provided by a connection platform according to some embodiments. The list shows that the participant has an upcoming conversation with Amanda, a coach, at 3-3:30 PM on January 15^{th}.

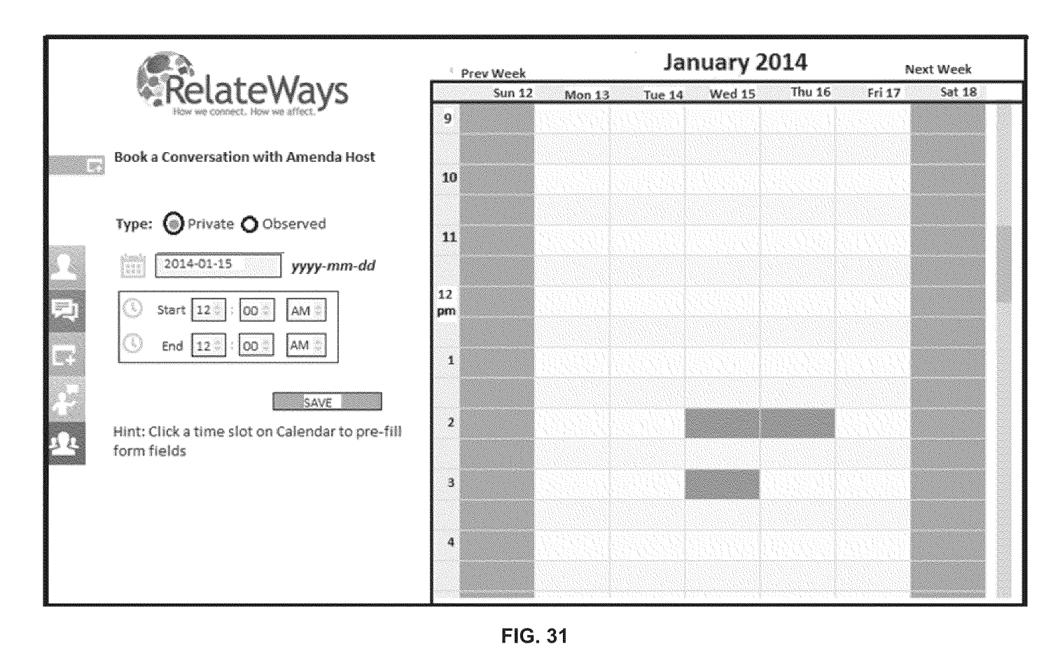

FIG. 31 is a user interface showing a calendar for a participant to book a conversation with a coach as provided by a connection platform according to some embodiments. The conversation may be scheduled to be a private conversation or a conversation that may be observed by non-participants, such as peers, managers, or other participants in the same group 805.

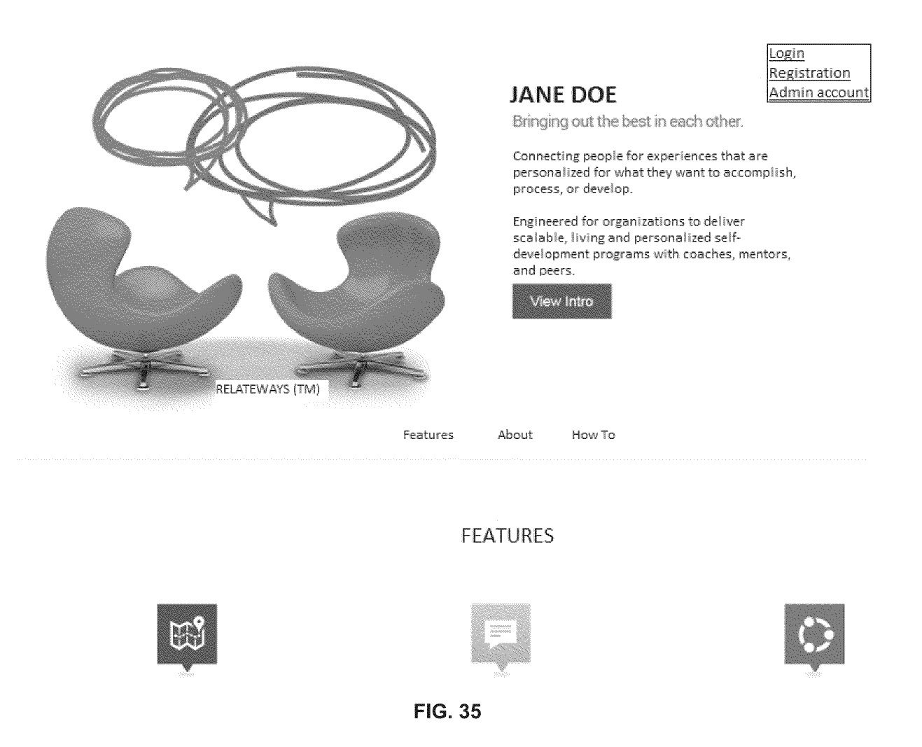

FIG. 35 is a user interface of a host landing page according to some embodiments.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present disclosure. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the present disclosure may be implemented as a web service, where the mobile device includes a link for accessing the web service, rather than a native application.

The functionality described may be implemented to any mobile platform, including the iOS™ platform, ANDROID™, WINDOWS™ or BLACKBERRY™.

It will be appreciated by those skilled in the art that other variations of the embodiments described herein may also be practiced without departing from the scope of the invention. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the disclosure, the scope of which is defined by the claims.

Except to the extent explicitly stated or inherent within the processes described, including any optional steps or components thereof, no required order, sequence, or combination is intended or implied. As will be understood by those skilled in the relevant arts, with respect to both processes and any systems, devices, etc., described herein, a wide range of variations is possible, and even advantageous, in various circumstances, without departing from the scope of the disclosure, which is to be limited only by the claims.

1. A system for a connection platform between at least one supporter device and at least one participant device, the system comprising:
at least one processor operably connected to the at least one supporter device and the at least one participant device;
an electronic data store persistently storing data reflecting a PathWays guide for the at least one participant device, wherein the PathWays guide comprises a tree structure of a plurality of data nodes, each of the plurality of data nodes representing an ordered collection of data records;
a network interface for coupling to a network operably connected to the at least one supporter device and the at least one participant device; and
a non-transitory computer-readable memory storage in communication with the at least one processor, the memory storage storing processor-executable instructions;
wherein the at least one processor, when executing the instructions, causes the system to:
receive electronic signals representing a first data record representing one or more primary foci of a participant operating the participant device, and a second data record representing an industry value of the participant;
store the first and second data records in the data store, wherein each of the first and second data records forms part of an ordered collection of data records of one or more of the plurality of data nodes of the PathWays guide;
retrieve a set of Mindset Questions from the data store based on the one or more primary foci and the industry value, the set of Mindset Questions forming part of an ordered collection of data records of one or more of the plurality of data nodes;
transmit, via the network interface, electronic signals representing the set of Mindset Questions to the at least one supporter device or the at least one participant device;
trigger display of the set of Mindset Questions on a user interface of the at least one supporter device or the at least one participant device;
receive electronic signals representing a modification command in association with the set of Mindset Questions via the network interface from the at least one supporter device or the at least one participant device;
modify data records representing the set of Mindset Questions in the data store based on the received modification command;
update the one or more of the plurality of data nodes and the respective ordered collection of data records of the PathWays guide based on the modified data records representing the set of Mindset Questions; and
trigger display of the updated PathWays guide on the user interface of the at least one participant device or the at least one supporter device.

2. The system of claim 1, wherein the modification command in association with the set of Mindset Questions comprises modifications to the one or more primary foci or the industry value.

3. The system of claim 1, wherein the modification command in association with the set of Mindset Questions comprises at least one answer to the set of Mindset Questions, and wherein the at least one answer is further stored in the data store as a data record forming part of an ordered collection of data records of one or more of the plurality of data nodes.

4. The system of claim 1, wherein the at least one processor further causes the system to record data signals representing one or more conversations exchanged between the at least one participant device and the at least one supporter device.

5. The system of claim 4, wherein each of the recorded conversations is in the form of text, audio or video.

6. The system of claim 5, wherein the recorded conversations are further stored in the data store as a data record forming part of an ordered collection of data records of one or more of the plurality of data nodes of the PathWays guide and configured to be accessed by the at least participant device or the at least supporter device.

7. The system of claim 1, wherein the at least one processor further causes the system to determine a recommended next step for the participant based on a predefined route of the PathWays guide, wherein the predefined route comprises an ordered collection of data records of a data node of the plurality of data nodes.

8. The system of claim 1, wherein the data store persistently stores a plurality of participant profiles including a profile of the participant, and wherein the at least one processor further causes the system to generate a report based on the plurality of participant profiles.

9. The system of claim 1, wherein the at least one processor further causes the system to provide access of an ordered collections of data records of one or more of the plurality of data nodes of PathWays guide to one or more devices of the at least one participant's peers invited by the at least one participant or the at least one supporter.

10. The system of claim 1, wherein the at least one processor further causes the system to provide a single sign-on interface, via the network interface, for the at least one participant device or the at least one supporter device.

11. A method for providing a connection platform between at least one supporter device and at least one participant device, the method comprising:
storing persistently a PathWays guide for the at least one participant device in an electronic data store, wherein the PathWays guide comprises a tree structure of a plurality of data nodes, each of the plurality of data nodes representing an ordered collection of data records;
receiving electronic signals representing a first data record representing one or more primary foci of a participant operating the participant device, and a second data record representing an industry value of the participant from the participant device via a network interface coupled to a network operably connected to the at least one supporter device and the at least one participant device;
storing the first and second data records in the data store, wherein each of the first and second data records forms part of the ordered collection of data records of one or more of the plurality of data nodes of the PathWays guide;
retrieving a set of Mindset Questions from the data store based on the one or more primary foci and the industry value, the set of Mindset Questions forming part of the ordered collection of data records of one or more of the plurality of data nodes;
transmitting, via the network interface, electronic signals representing the set of Mindset Questions to the at least one supporter device or the at least one participant device;
triggering display of the set of Mindset Questions on a user interface of the at least one supporter device or the at least one participant device;
receiving electronic signals representing a modification command in association with the set of Mindset Questions via the network interface from the at least one supporter device or the at least one participant device;
modifying data records representing the set of Mindset Questions in the data store based on the received modification command;
updating the one or more of the plurality of data nodes and the respective ordered collection of data records of the PathWays guide based on the modified data records representing the set of Mindset Questions; and
triggering display of the updated PathWays guide on the user interface of the at least one participant device or the at least one supporter device.

12. The method of claim 11, wherein the modification command in association with the set of Mindset Questions comprises modifications to the one or more primary foci or the industry value.

13. The method of claim 11, wherein the modification command in association with the set of Mindset Questions comprises at least one answer to the set of Mindset Questions, and wherein the at least one answer is further stored in the data store as a data record forming part of an ordered collection of data records of one or more of the plurality of data nodes.

14. The method of claim 11, further comprising recording data signals representing one or more conversations exchanged between the at least one participant device and the at least one supporter device.

15. The method of claim 14, wherein each of the recorded conversations is in the form of text, audio or video.

16. The method of claim 15, wherein the recorded conversations are further stored in the data store as a data record forming part of an ordered collection of data records of one or more of the plurality of data nodes of the PathWays guide and configured to be accessed by the at least participant device or the at least supporter device.

17. The method of claim 11, further comprising determining a recommended next step for the participant based on a predefined route of the PathWays guide, wherein the predefined route comprises an ordered collection of data records of a data node of the plurality of data nodes.

18. The method of claim 11, wherein the data store persistently stores a plurality of participant profiles including a profile of the participant, and wherein the method further comprises generating a report based on the plurality of participant profiles.

19. The method of claim 11, further comprising providing access of an ordered collections of data records of one or more of the plurality of data nodes of PathWays guide to one or more devices of the at least one participant's peers invited by the at least one participant or the at least one supporter.

20. The method of claim 11, further comprising providing a single sign-on interface, via the network interface, for the at least one participant device or the at least one supporter device.
